(19) United States
(12) Patent Application Publication
(10) Pub. No.: US 2006/0005017 A1
(43) Pub. Date: Jan. 5, 2006

(54) Method and apparatus for recognition and real time encryption of sensitive terms in documents

(76) Inventors: Alistair D'Lougar Black, Los Gatos, CA (US); Constantin Stelio Delivanis, Los Altos Hills, CA (US)

Correspondence Address: RONALD CRAIG FISH, A LAW CORPORATION, PO BOX 820, LOS GATOS, CA, 95032, US

(21) Appl. No.: 10/874,399

(22) Filed: Jun. 22, 2004

(51) Int. Cl. H04L 9/00

(52) U.S. Cl. 713/165

(57) ABSTRACT

A process for automatically selecting sensitive information in documents being displayed and/or generated on a computer to select sensitive information for encryption using pattern recognition rules, dictionaries of sensitive terms and/or manual selection of text. The sensitive text is automatically encrypted on the fly in the same manner as a spell checker works so that the sensitive information immediately is removed and replaced with the encrypted version or a pointer to where the encrypted version is stored. The keys used to encrypt the sensitive information in each document are stored in a table or database, preferably on a secure key server so that they do not reside on the computer on which the partially encrypted document is stored. Several learning embodiments that determine overinclusion and underinclusion errors in various ways and make adjustments to the rules and/or dictionary entries used to select sensitive information to reduce the errors are disclosed. Public-private key pair encryption algorithms and data structures to keep all the encryption keys stored such that they can be located is disclosed.

### FIELD OF USE AND BACKGROUND OF THE INVENTION

There is a great deal of personal, sensitive information sitting in documents on personal computers desktops, databases and file repositories on servers. One of the problems with databases is that they are persistent, often beyond the expectations and assumptions of the users. This creates a problem of a large amount of sensitive information residing in computers without any person knowing about it until the data is discovered by somebody accidently or is located by an unscrupulous person and used to steal identities, make fraudulent purchases, etc.

Protecting sensitive information such as social security numbers, addresses, mother's maiden names, phone numbers, FAX numbers, email addresses, income and employment information etc. is becoming more important every day. Identity theft is one of the fastest growing crimes in America and worldwide. In addition, spammers and telemarketers are very interested in scavenging email addresses phone numbers and email addresses from as many people as possible so as to bombard them with offers to buy things.

Single pieces of information like social security numbers alone are usually not enough to commit a crime. It is when an unscrupulous person gathers a great deal of information about a person that identity theft can occur. It is important therefore to protect as much of the information about a person as is possible.

Sensitive information is entered into forms that are filled out on computers and in documents that are written on computers. Typically, these documents are written and forms are filled out on client computers and stored in databases and document repositories on servers to which the client computer is coupled via a network or are stored locally on the client computer or in both places. If there is internet access by the client computers and/or servers, or modem connections hackers can break into the system and steal sensitive information from these databases and repositories. In addition, these documents and forms are sometimes sent over the internet in email which is not a secure medium and can subject sensitive information to prying by persons with other than pure motivations. Sensitive information can fall into the wrong hands by this avenue also.

The problem with encrypting entire files (documents) stored in computers is that the persons working with the files needs to decrypt them to work on the documents. This is a hassle and slows down work, so most people do not encrypt their files. Even if the files are encrypted, the key is on the computer somewhere usually. If the computer is stolen or sold at auction in a bankruptcy and the hard drive is not cleaned, sensitive information can be lost to unscrupulous persons if the documents are not encrypted or if they are encrypted and the buyer of the computer finds the key to decrypt the files.

Further, besides the theft and sale at auction scenarios, opportunistic crime is also on the rise. If the economy continues in its recessionary funk or recovers and goes back into a funk later, opportunistic crime will rise as people who are desparate for money turn to crime. Thus, even if all computers in an organization have user names and passwords to log on and even if documents stored on the computers are fully encrypted, the sensitive information in the documents is still not safe from employees working with the documents. In other words, unscrupulous employees of organizations who have access to sensitive information of customers, such as files they decrypt to work on or just access to work on, can sell that information to identity theft rings because they know the passwords and decryption keys. There has been one documented case where a receptionist at a doctor's office sold sensitive information of patients to an identity theft ring which resulted in hundreds of identity thefts. In another case, a disgruntled employee who felt she was not being paid sufficiently posted the records of customers of her employee on the internet to damage her employer and subject it to lawsuits for breach of privacy.

It takes a great deal of effort and time on the part of an identity theft victim to straighten out ruined credit and get bill collectors off his or her case. Bill collectors are not susceptible to being easily convinced that their target was the victim of an identity theft.

Prior art document encryption systems such as Pretty Good Privacy encrypt the entire file using a public key, private key arrangement. To encrypt a document to be sent to a specific recipient, the user must send her private key to the sender who then uses it to encrypt the document. The encrypted document is then decrypted with the recipient's private key and read. All this is a hassle, and that fact makes the system only useful for highly secure communication. Further, such prior art does not protect the sensitive information if somebody steals the disk drive or the computer upon which the encrypted documents are stored or the computer is sold at auction and the new possessor gets access to the public and private key rings stored on the drive. The same is true for database systems such as Oracle which encrypt the database. Neither prior art system protects sensitive information from the authorized users thereof or from buyers of the computer or thiefs if the keys to decrypt the files are stored on the computer. Further, passwords and keys can be surreptitiously learned using keyboard loggers which log keystrokes of a computer a hacker wants to break into and emails the keystrokes to some email address the hacker specifies.

Accordingly, a need has arisen for a method and apparatus to secure sensitve information in a document even from the person who enters it into a computer system or works with the documents. The needed system will partially encrypt a document to protect just the sensitive information but otherwise leave the document in a readable state. In other words, sensitive information is exposed to the extent the degree of security applied to the computer is weak. Further, sensitive information is always exposed to the employees of an organization that have to work with the data, and no amount of security applied to the log on process or encryption of individual documents can reduce that risk. There is a need to change that paradigm so that the data itself is secure even from the people who created the document or have to work with the documents (unless they have a photographic memory) and regardless of the degree of security applied to the computer itself. The need has also arisen to correct the problem of sensitive information in databases just lying around without anybody knowing about it. There is a need for a system that will automatically encrypt sensitive information in real time as it is entered into a database and store the keys, preferably elsewhere on separate key servers.

### BRIEF DESCRIPTION OF THE DRAWINGS

FIG. 1 is a diagram illustrating a combination of information elements that a bank might have collected about its customers for purposes of authentication to verify they are who they say they are.

FIG. 2 is a flowchart illustrating the genus of the process including the minimum steps that all species within the genus must do to practice the teachings of the invention.

FIG. 3 is one example of a key storage table using a column for every document with the encryption keys for every piece of sensitive information in the document stored in rows in the column assigned to the document in which the keys were used.

FIG. 4 is a flowchart of a learning process to modify a set of rules to improve their selection accuracy.

FIG. 5 is a hardware block diagram that illustrates a typical installation in which the invention is practiced.

FIG. 6, comprised of FIGS. 6A and 6B, is a flow diagram of the preferred species of the invention that includes a learning process and an automatic error reporting process.

FIG. 7, comprised of FIGS. 7A and 7B, is a flowchart of an alternative embodiment where the client system does on the fly encryption and learning, but does not automatically report errors to a server somewhere, but stores them and waits of a server to ask for them.

FIG. 8, comprised of FIGS. 8A and 8B, is a flowchart of an alternative embodiment where a client system does on the fly encryption and learning only with no error storage or reporting.

FIG. 9 is a diagram showing the data structures of the encrypted sections of a document and an ID directory file which stores mapping entries which map document IDs and segment IDs to pointers to key servers and particular keys that were used to encrypt each encrypted segment.

FIG. 10 comprised of FIGS. 10A and 10B, is a flowchart of the security application process on the client computer and key server to create document IDs and segment IDs, send key requests, receive key requests and create mapping entries, issue keys and encrypt sensitive data.

FIG. 11 is a flowchart of a first species of a process to use public-private key encryption to partially encrypt document segments.

FIG. 12 is a flowchart of a second species of a process to use public-private key encryption to partially encrypt document segments.

### SUMMARY OF THE INVENTION

A software process according to the invention works to protect sensitive information as it is entered (or encrypting the sensitive information only after some fixed or programmable delay or upon receiving a command from the user) while otherwise leaving the document in a readable state. In one species, the invention works much like a grammar or spell checker program. That it, the invention is a function within a word processor or spreadsheet or database application to partially encrypt a document or database entries on an ongoing, real time basis as a background process which is always running to recognize sensitive information and encrypt it. Each piece of sensitive information is recognized, encrypted and the sensitive information is replaced with labelled segments which contain data to find the proper key to decrypt the encrypted version of the sensitive information. Typically, the sensitive information is replaced with the encrypted version thereof and suitable labels to find the proper key.

In other species, the invention may be practiced as a batch process on any .pdf, .doc, xis, .wpd or any other word processing, spreadsheet, database or other file after the file has been completely created. In the batch process, the documents or files being processed do not have to be displayed on the computer. In the batch process, every time (or some predefined or programmable time later) a document is saved that may have sensitive information, it is automatically encrypted by one of two methods.

1) In the first method, the process and apparatus of the invention work directly on the files themselves. Something in the prior art which is in some ways similar is the Java library calls that operate on Excel spreadsheet files directly. This is discussed at the website http://www.andykhan.com/jexcelapi/.

2) In the second method, the process of the invention launches an actual instance of the program in the background and operates on the opened file with a simple set of scripted commands such as find and replace that will perform the scan of the text and the replacement of sensitive segments.

In another species, protection of sensitive information is performed by creating a web application (such as those created using the Microsoft.net environment). In this species, the web application makes a function call to an application programmatic interface within Microsoft Word or Microsoft Excel to gain access to read a document, spreadsheet or database file. The web application then runs a background process that finds the sensitive information segments, performs encryption of the sensitive segment(s) through a process that is implemented by the web application. The sensitive segment(s) are then overwritten with the encrypted version thereof and pointer information to enable finding the key used to encrypt the sensitive segment or pointer information suitable to find the sensitive segment's encrypted version (stored elsewhere) and the key needed to decrypt it. The open source Java Excel API that exists in the prior art can be used to allow non Windows operating systems to run pure Java applications which can both process and deliver Excel spreadsheets. Because it is Java, this API may be invoked from within a servlet, thus giving access to Excel functionality over internet and intranet applications. The Java Excel API allows reading Excel spreadsheets and generating Excel spreadsheets dynamically. It contains a mechanism which allows Java applications to read in a spreadsheet, modify some cells and write out the new spreadsheet. Because it is open source, its code can be modified to do the sensitive information segment recognition, encrypt the sensitive information, store the keys used to encrypt it and replace the sensitive information with the encrypted version and pointers to the keys or pointers to both the encrypted version stored elsewhere and the key, and then access the original Excel file and overwrite it with the protected version. This can be done locally on the machine on which the Excel files are stored or remotely using a web application that implements the process of the invention and which can access Microsoft Word or Excel files remotely over the internet, modify them and replace them on the client.

Recognition of sensitive information is important to the invention. Using predetermined rules of recognition, sensitive information such as words, phrases or entire sections of the document or database field being worked upon by the host word processor or spreadsheet or database program are selected for encryption either in real time of after a delay. In other embodiments, encryption is done after a delay or on one or more documents after the user signals by giving a command to partially encrypt the documents.

The encryption is done and the sensitive information is replaced with an encrypted set of characters. The key to decrypt that information is not available anywhere on the client computer in the preferred embodiment and is stored in one or more secure key servers by a secure server process elsewhere on a network. Note that this means that sensitive data can be automatically destroyed in one or more documents without touching the documents themselves simply by destroying the keys.

In operation, the client computers create unique document IDs and unique segment IDs and send these to a key server with a key request to request a key to encrypt each piece of sensitive information as the sensitive information is encountered (or after a delay in some embodiments). In some non preferred embodiments, the real time encryption process is performed fully on the client computer or a stand alone computer not coupled to the network. In these embodiments, all the encryption keys are stored in a file which is itself encrypted with a highly secure encryption system or an unbreakable encryption system such as a one time pad system.

In general, the genus of processes according to the teachings of the invention is defined by the following characteristics that all processes within the genus will share.

1) All species will select sensitive information for encryption in any way such as by using predetermined selection rules, a dictionary or manual selection or any combination of techniques.

2) That sensitive information will be encrypted using any encryption algorithm. In some species, the sensitive information is replaced with the encrypted version, and pointer information to the key. In this species, the sensitive information is replaced with its encrypted version both on the displayed version of the document and in any stored version of the document. This is done either as soon as the sensitive information is entered and recognized as a piece of sensitive information or after a delay in some species. In other species, the sensitive information is replaced with pointer information pointing to the encrypted version of the sensitive information and to the key needed to encrypt.

3) The keys for each encrypted piece of information will be stored on a secure server elsewhere on the network or in a secure, encrypted file on the computer on which the document was created or input from any source and stored. In some species, public-private key pairs are used. In other species, secure protocols are used with a disposable session key being used to transfer information back and forth between the key server and the client computer. IDs and pointers and mapping files or ID directories will be used to find the key used to encrypt each segment of encrypted information.

4) Authenticate a user who is requesting access to a protected document in the clear as a person who is on a list of authorized persons who have access to the secure server or the secure file of keys.

5) If user is authenticated, use appropriate keys in secure server or secure file to reconstitute segments of protected document or portions thereof for display, printing or re-storing as a non-protected document.

Typically, selection and encryption processes that perform in accordance with characteristics 1 and 2 defined above will work in the background of other programs such as Microsoft Word, WordPerfect, Filemaker Pro or other word processing and database programs. Typically, the process(es) work like a spell checker and runs continuously to automatically select and encrypt sensitive information as it is entered or after a delay in some species. In other species, a process called “automation” (formerly called OLE automation) is used to take advantage of an existing program's content and functionality and incorporate it into another application. In this species, a security application is written which does the recognition and encryption of sensitive information in any of the ways described herein. Then the automation process is used to incorporate into this security application the functionality of Microsoft Word, Microsoft Excel or any other application program that is based upon the Component Object Model (COM) standard software architecture. COM is a standard prior art software architecture based upon interfaces that is designed to separate code into self-contained objects or components. Each component exposes a set of interfaces through which all communication to the component is handled. For example, the security application can use the Word write and edit functionality to create documents and then process them to protect the sensitive information using the automation process and the COM architecture. Likewise, the security application can use the Excel functionality to create, program, edit, print and do other things with Excel and then process the spreadsheet to protect the sensitive information therein. In this way, the security application does not need to have its own code to do the complicated calculation engine to provide the multitude of mathematicaly, financial and engineering functions that Excel provides. Instead Excel or Word is automated to “borrow” the functionality needed and incorporate it into the security application. The security application simply invokes whatever functions from Word or Excel or any other application written based upon the COM software architecture by making the proper function call(s) to the API of the module that performs the needed function.

The predetermined rules for selection of which information is encrypted can be as varied as the types of information to be protected and the rules will usually differ from one area of application to another and be dependent upon what types of information are considered to be sensitive enough to require encryption. The exact selection rules are not critical to the invention. Any selection rule that reliably picks out the sensitive information of a document for encryption will suffice to practice the invention. Examples of the types of selection rules which may be used are:

1) By comparison of user entered information in the form of text, formulas, or other symbology to a dictionary of terms or items that need to be protected, and using the results of the comparison to select for encryption terms that are in both the dictionary and the document being drafted or filled in.

2) By examining the document being processed and applying rules for selection such as: words with initial caps that come in pairs or triplets are proper names; 7 or 10 digit numbers are phone numbers; 9 digit numbers with a pattern 3 digits followed by a space or hyphen followed by 2 digits followed by a space or hyphen followed by 4 digits are social security numbers; any number followed by one or more words which are capitalized with no period between the number and the next capitalized word is assumed to be an address; or any other pattern such as a form with has fields named “address” or “mother's maiden name” or “household income” or “bank account number” or “credit card number” any other sensitive information will have everything following the field label to the next field label selected for encryption.

3) By manual selection of text to be protected in any known way such as giving a protect command and pointing to the beginning and end of the text to be encrypted, or by dragging a mouse cursor over the text to be encrypted or by giving coordinates in the document of the beginning and end of the text to be encrypted.

In some embodiments, there is a learning process to learn the patterns of text that is manually selected for encrypting and to learn text which is manually selected which was erroneously selected for encryption by operation of some rule but which was not sensitive information. In some embodiments, the user can invoke tools to point out overinclusion errors and underinclusion errors manually after a document has been processed by the automated process. These errors are then analyzed and one or more new rules and/or dictionary entries may be generated which if added to the existing rules and/or dictionary would have eliminated or reduced the chance of such errors occurring in the future. This learning process can add rules or delete or modify rules and/or dictionary entries as the learning process proceeds.

Once the text to be encrypted is selected, that text is removed and relaced by a coded word or phrase that can be used to later locate the encrypted text and decrypt it or which can be decrypted itself to reveal the original text.

Preferably, the key or keys used to encrypt the various pieces of sensitive information in each document are stored in a secure key server and are not stored on the computer where the partially encrypted document(s) are stored.

### DETAILED DESCRIPTION OF THE PREFERRED AND ALTERNATIVE EMBODIMENTS

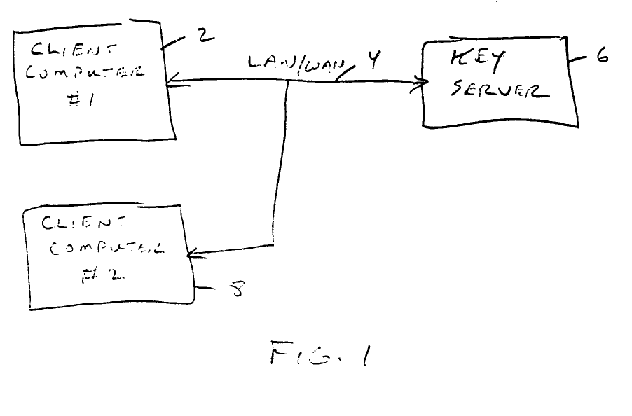

FIG. 1 is a diagram illustrating the typical computing environment in which the inventive apparatus and method can be found. Client computers 2 and 8 upon which documents with sensitive information are being typed or otherwise processed, are coupled via local area or wide area network 4 to a key server 6. Each client computer has a keyboard, display, pointing device, central processing unit and usually has some sort of bulk storage device to read and write data on media such as a hard disk drive, CD-ROM, etc. The client computers execute a security application program that recognizes sensitive information in a document, obtains a key to encrypt the sensitive information and immediately or after some delay encrypts the sensitive information and then stores the encryption key.

The encryption keys for each document are stored in a table like that shown in FIG. 3B where all the keys for all the encrypted pieces of information in a document are stored in a column which is designated with the code of the document, the collection of columns each having rows which are the encryption keys comprising a table. In the preferred embodiment, the table is stored in key server 6. The encrypted text in each document is appended or prepended or otherwise associated with a pointer to the key used to encrypt it or an identification code of the key used to encrypt the sensitive information. The identification code or pointer used to find the key needed to decrypt each piece of sensitive information should allow for change of name of the document and/or the deletion or re-ordering of various segments of the document/database without requiring renumbering of the identification codes or otherwise altering of the pointers.

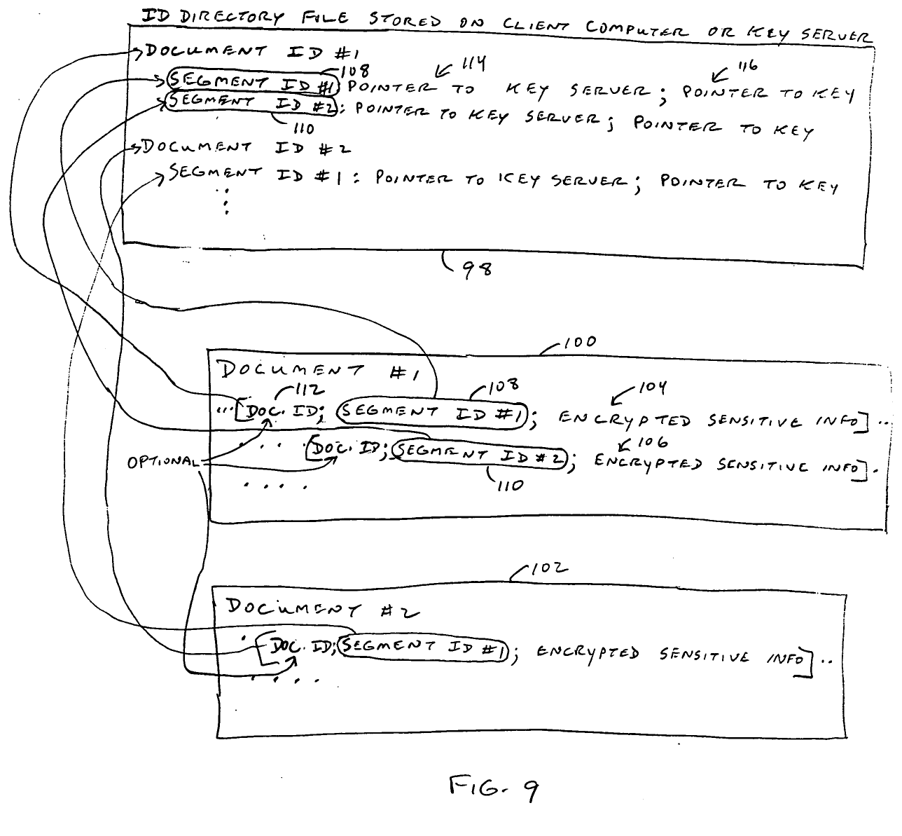

Key management can be done in several ways. The first way, illustrated in FIG. 9, is to keep a separate ID directory file 98 managed by the security application that stores all the document IDs, encrypted segment IDs for encrypted segments in each document and pointers to the key server which stores the key used to encrypt the segment along with the information needed to find the correct key. Each segment IDs must be connected to the appropriate segment in the document. In the preferred embodiment, this is done through a coding which places a segment ID at the front of each encrypted piece of data. The segment ID must have a large enough number of bits and be generated in such a way as to prevent accidental use of the same number within the group of documents within the system (or at least within the same document if some other means of separating the keys for each document is used). For example, suppose two documents 100 and 102 each have encrypted segments. Document 100 has two encrypted segments at 104 and 106. Each of these encrypted segments has its own unique segment ID prepended to the encrypted text at 108 and 110, respectively. These encrypted segment IDs 108 and 110 are included in separate entries in the ID directory file 98 under a section labelled document ID #1. Document ID #1 is a unique document ID that does not change when the name of the document 100 is changed and which is unique within the system such that one and only one document is referred to by document ID #1.

Each segment ID entry in the ID directory file 98 includes a pointer to the key server upon which the key used to encrypt that segment is stored, and a pointer to the actual key used to encrypt the segment, shown at 114 and 116, respectively. Also placed at the front of each encrypted segment, in one embodiment, is a document ID that uniquely identifies the document (regardless of its filename) and relates it to the ID directory file that holds all the pointers to keys used to encrypt segments within that document.

In the embodiment illustrated in FIG. 9, every encrypted segment such as segment 104 in document 100 has prepended to it a document ID shown at 112 that uniquely identifies the document. In some embodiments, the document ID also serves to point to the particular ID directory file 98 as the file which stores all the pointers to the key server and keys for document 100 and which also includes the document ID. In some embodiments, the document ID does not have to also point to the ID directory file because the security software knows where the proper ID directory file for this document is. An example would be an embodiment where there is only one ID directory file per client computer. Another example would be an embodiment where there is only one ID directory file stored on the key server and serving the entire system.

In alternative embodiments, only a segment ID which is globally unique need be prepended to the encrypted segment since the uniqueness of the segment ID assures that it can be found in a search of all ID directory files like file 98 in the system. Use of a unique document ID in addition to a unique segment ID allows the size of the segment ID in terms of bits to be smaller as it is the concatenation of the document ID and the segment ID which is globally unique and which allows the proper key to be found.

The document ID and segment IDs (or just the segment ID in embodiments where only a globally unique segment ID is used) prepended to each encrypted segment of a document must be unique, or at least the combination of the two must be unique. In the preferred embodiment, each of the document ID and the segment ID is a 128 bit code. In an alternative embodiment, a separate ID directory file on the client computer (that may itself be encrypted) contains translations that take the unique segment IDs and relates them to an index on the key server that points to the document in which the encrypted segment resides and points to the proper key required for decryption.

The advantage to this first class of embodiments is that the required IDs may be smaller since there is not one big ID directory file on the key server which contains the document IDs for every partially encrypted document in the system and the segment IDs for every segment in every document without duplication of document IDs or segment IDs. Such a centralized system would require fairly large IDs to avoid duplication, but would be simpler. The disadvantage of the first class of embodiments is that the IDs can be smaller, but, since there are more ID directory files, the system is more complex.

A second class of embodiments stores on the key server a single ID directory file containing the keys for all encrypted segments of all documents on the system. In this class of embodiments, one simply makes the Directory ID and the segment ID large enough in terms of bits to assure that they can hold a unique number which points to a key on the key server without duplication even though the keys for a large number of encrypted segments are stored in the same ID directory file on the key server. In this embodiment, the security software has to be smart enough to create a unique document ID each time using any of the many techniques known in the art. For example a time stamp combined with other techniques may be used to create the document ID when the first segment is encrypted, and then the same document ID is used thereafter to encrypt all other segments in the same document. Time stamps along with other known methods can also be used to create unique segment IDs. Unique segment IDs at least within a document are a must, and the segment IDs must be created such that when a segment of a document containing encrypted portions is deleted, the segment IDs of the deleted portions are not later duplicated in other parts of the document. When a section of a document containing encrypted sections is copied, the encrypted sections can be decrypted using the same keys that are identified in the copied encrypted sections. In cases where a section containing encrypted text is deleted and replaced with sensitive information, a new key is used to encrypt the sensitive information and a new segment ID is created and a new entry in the appropriate ID directory file for the new encrypted segment or segments is created.

The document ID and segment ID (or just the segment ID in embodiments where the segment ID is globally unique) must be sent to the key server each time a key is requested to encrypt a segment of a document. This allows the security application executing in the key server to associate the key it issues with the document in which the key was used to encrypt a segment and to create a link between the encrypted segment, the key used to encrypt the segment and the document in which this encryption occurred. In some embodiments, the entry created by this linking is stored in a single ID directory file stored on the key server. In other embodiments, the entry created by this linking is sent to a secure ID directory file stored on the client computer on which the document or database having encrypted segments is stored.

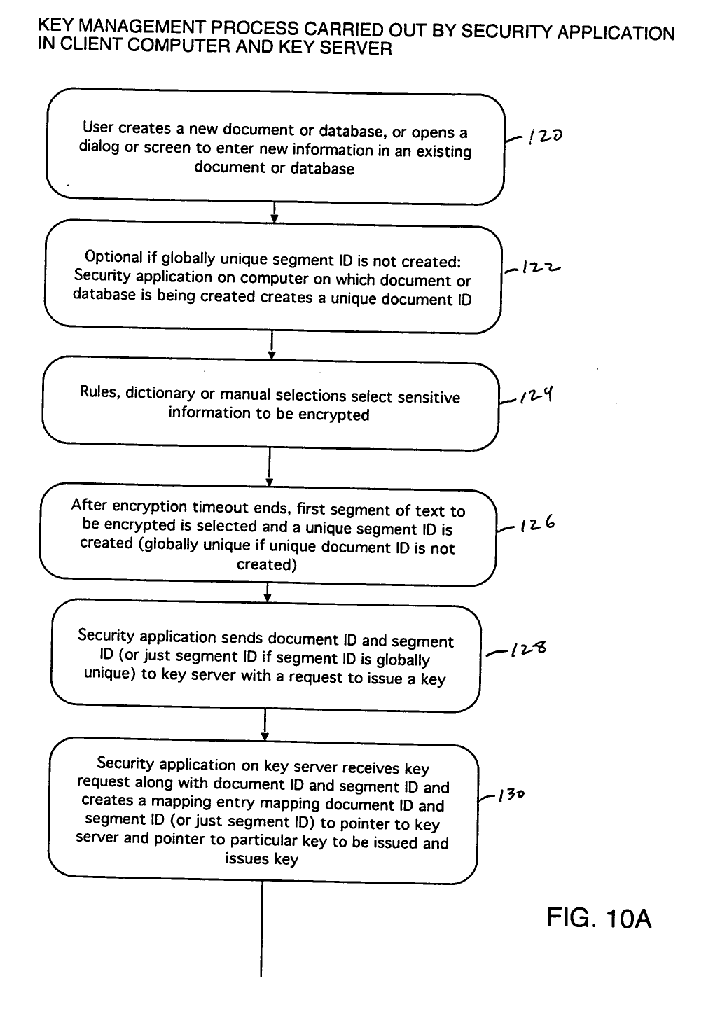

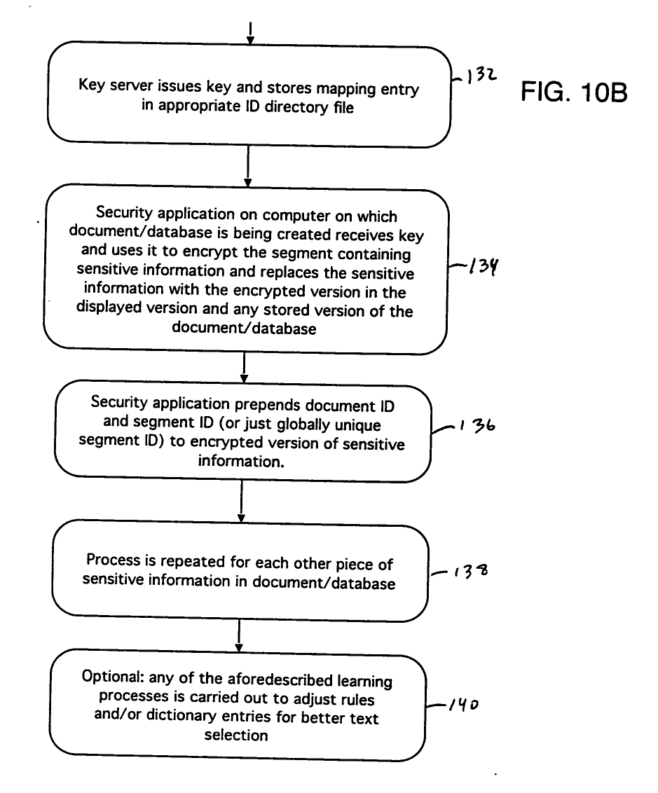

Referring to FIG. 10 comprised of FIGS. 10A and 10B, there is shown a flowchart of the security application process on the client computer and key server to create document IDs and segment IDs, send key requests, receive key requests and create mapping entries, issue keys and encrypt sensitive data. The process starts out with step 120 representing the user creating a new document or database or opening a dialog box or screen to enter new information in an existing document or database. Step 120 is an optional step which is performed if globally unique segment IDs are not created and a document ID is needed to combine with the segment ID to make a unique combination. “Globally unique” in this context means a segment ID which is unique within the universe of documents and/or databases within the system of key servers, other servers and client computers and not necessarily in the entire world. Assuming a globally unique segment ID is not being created, step 120 represents creation of a unique document ID that will not change even if the file name of the document is changed. This is done by the security application on the client computer where the document or database is being processed in response to the creation of a new document or new database or opening an existing document or database or opening a dialog or other computer display to add new information to an existing document or database.

Step 124 represents the process of using the predetermined selection rules and dictionary entries and/or manual selections to select sensitive text for encryption. Of course, in databases, the fields have semantic labels, and the fields associated with each label can be predetermined to be sensitive or not depending upon the semantics of the label. For example, a customer identity database which includes fields in which are entered name, address, social security number and mothers maiden name along with other non sensitive fields requires only rules that say whatever is entered in the name, address, social security number and mother's maiden name fields is to be encrypted because we know that information is sensitive in advance and no further processing is needed. Step 126 represents the process of waiting for an encryption timeout to occur and then selecting the first segment of sensitive text to encrypt and creating a unique segment ID for that segment of text. The timeout could be zero meaning immediate encryption upon entry or it could be some programmable number set by the user to allow for proofreading or quality control. The step of waiting for timeout could also be eliminated and sensitive information could be immediately encrypted upon entry and recognition in one important class of embodiments. The unique segment ID must at least be unique within the document, and if no unique document ID is created in addition to the segment ID, then the segment ID must be created to be “globally unique” as that term was earlier defined.

In step 128, the security application sends the document ID (if any) and the segment ID (or just the segment ID if it is globally unique) to the key server with a request for a key for use in encrypting the text associated with the segment ID. In step 130, the key server's security application receives the key request and responds by creating a mapping entry such as any of the ones shown in ID directory file 98 in FIG. 9. The ID directory file may be stored on the client computer where the request originated, some other computer in the system or on the key server. The mapping entry associates the document ID to the segment ID to a pointer to the appropriate key server upon which is stored the key used to encrypt the segment uniquely identified by the document ID and segment ID and a pointer to the particular key used. Where the ID directory file is stored depends upon the particular species within this class of embodiments. Step 132 represents the process of the key server issuing the key and storing the mapping entry in the appropriate ID directory file. Step 134 represents the process of the security application on the computer on which the document/database is being created or processed receiving the key and using it to encrypt the segment associated with the segment ID. Step 134 also represents the process of replacing the sensitive text with the encrypted version.

Step 136 represents the process of the security application on the client computer prepending the document ID and segment ID (or just the segment ID if a globally unique segment ID was created) to the encrypted text. Step 138 represents the process of repeating the above described process for each other segment of sensitive text to be encyrpted. Step 140 represents an optional step of carrying out any of the learning processes described herein to adjust the rules and/or dictionary entries for better text selection.

It may be confusing to an operator to have sections of a document disappear before their eyes in real time and be replaced with encrypted text. Operators who wish to proof their typing may be frustrated by this. Accordingly, in some embodiments, a delayed encryption by some fixed or programmable time is used to allow the document to be completed or proofread or for checking against a list for completeness. In these embodiments, the text selected for encryption should be hightlighted, underlined or in any other way signalled to the user before it disappears into encrypted state so that the user can tell which parts of the document need to be checked. In some embodiments, the document is not processed for encryption of sensitive information until the user requests the document or a batch of documents to be processed to select the sensitive information and encrypt it or the sensitive information is not encrypted until after some fixed or programmable delay. In some embodiments, a fixed or programmable delay may be implemented for proofreading, but some information may be so sensitive that it is desirable to have it encrypted immediately even though the remaining items of sensitive information are not encrypted immediately. This can be implemented, in one species, by the user marking items of extremely sensitive information with some special, predefined control characters or prearranged symbols which signal the security application that the items of information so marked must be encrypted immediately even though the remaining items of sensitive information not so marked are to be encrypted only after some delay.

In a second species, a hot key combination is used which causes encryption on the fly. In this species, whenever the user presses the hot key combination, the security application encrypts whatever the user types “on the fly”, i.e., as the user types it. Encryption continues until the user presses the hot key combination again or presses another prearranged hot key. The text that is encrypted is replaced with the encrypted version thereof and a pointer to where the key to decrypt it may be found. In a third species, whenever the user presses a hot key, whatever is being typed is encrypted and the encrypted information is stored somewhere and the information being typed is replaced with a predefined set of characters the type of which is established in a configuration file. For example, a configuration setting may be set to replace the text being typed and simultaneously encrypted with a predefined name such as Bruce Smith or another setting may be made to replace the text being typed and simultaneously encrypted with x's or asterisks. In either case, the predefined text is stored where the original information was along with pointers to where the encrypted version of the original information and a pointer to the necessary decryption key is also stored.

Returning to the consideration of FIG. 1, in the preferred embodiment, the security application executing on client computers 2 and 8 each works like a spell checker which checks to recognize sensitive information constantly in the background. When sensitive information is recognized, the security application immediately requests a key from the key server and encrypts the sensitive information and replaces the display of the sensitive information with the encrypted information.

FIG. 3A is a diagram illustrating a combination of sensitive information elements that a bank might have collected about its customers for purposes of authentication to verify they are who they say they are. While the content of these identity templates will vary from business to business, the identity template of FIG. 3A is fairly typical. Block 10 stores the customer's mother's maiden name. Block 12 stores the customer's address. Block 14 stores the customer's phone number. Block 16 stores the customer's social security number. Block 18 stores a password selected by the customer. The concatenation of this information, when correctly recited by a customer on the phone, virtually assures that a customer is who he says he is.

All this information can rarely be found in a single document. However, if an identity thief has access to enough documents containing information about a person, such an identity template can be patched together. For example, one document may have a victim's mother's maiden name and address. Another document may have the victim's address and social security number and phone number. Another document may have the victim's social security number and the user selected password. It is important to encrypt all these pieces of sensitive information in all documents in which they appear such that if an identity thief somehow gets access to a number of documents containing information about an individual, the identity thief still will not be able to patch together an identity template.

This problem was not as severe when documents were stored on paper. But now that databases exist that contain a wealth of information about individuals and other documents exist in electronic form which also contain information and which can be easily hacked into, the problem has become much worse. Documents in electronic form sit around on the hard drives of non-secure personal computers, are backed up sometimes and can be accessed remotely over the internet. Worse, when a company goes bankrupt and is liquidated, its computers can fall into the hands of unscrupulous individuals, including ex-employees of the bankrupt company who buy computers at auction and who know the passwords. These unscrupulous people may sell the sensitive information found on the hard drives of client computers and servers unless somebody has the presence of mind to wipe the drives clean or change the passwords before the liquidation auction.

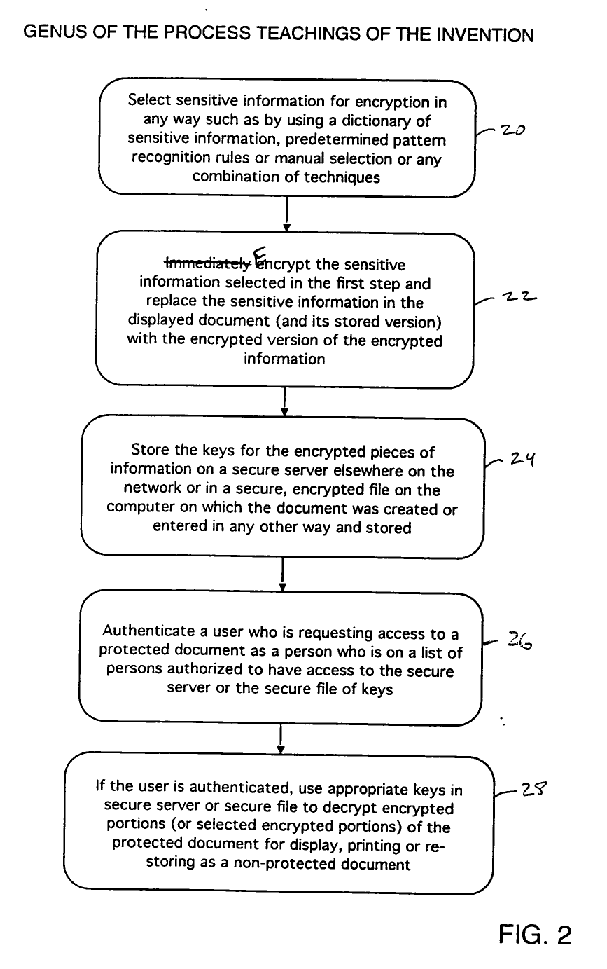

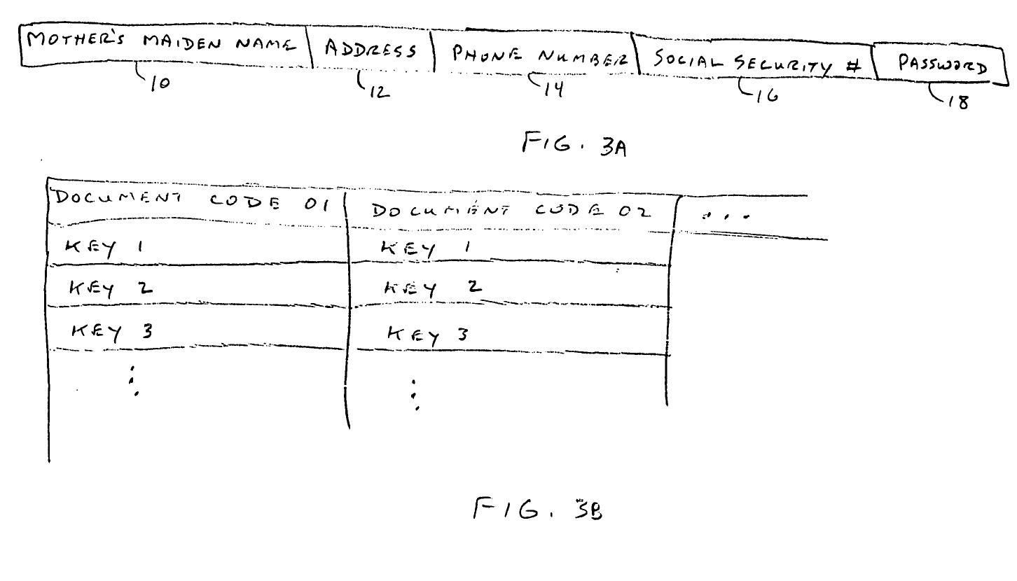

### The Process Genus: FIG. 2

The solution to this problem is to detect sensitive information such as information that might be in an identity template, immediately encrypt the sensitive information as it is entered in the computer and then store the keys in a secure manner. There are many ways of doing this general process, but we start with a general description of the process genus, represented by the flowchart of FIG. 2. Step 20 represents the process of selecting sensitive information in a document or database record for encryption. This can be done in any way. One way is to use a dictionary of sensitive information and to look up each word or phrase as it is typed to determine if there is a match with any entry in the dictionary. Another way is to allow the user to manually select sensitive information for encryption. This can be done by dragging a mouse driven cursor over text to be encrypted and giving an encrypt command. Encryption and storing of the key in a secure file would then follow automatically. Another way of selecting information for encryption in database records is to use the semantic label of each field in a database record and to decide in advance which fields will contain sensitive information such as name, address, income level, mother's maiden name, etc. Then whatever information is entered in these preselected fields will automatically be encrypted while the information in other fields will be left unencrypted. Another way of selecting sensitive information for encryption would be through use of predetermined pattern recognition rules. Examples of such rules will be described below. Another way is to automatically select for encryption whatever is entered in blank fields following certain field labels on a form a user fills out on a computer. For example, a form may have fields for mother's maiden name, social security number, telephone number, zip code, address, credit card number, bank account number, etc. All these pieces of information would be valuable to an identity thief, and the process of the invention knows that. As a result, all fields of the form that have field labels indicating what is filled in the field that follows the label or is associated therewith will be selected for immediate encryption. In the preferred embodiment, a combination of all these methods is used.

Step 22 represents the process of encrypting the sensitive information selected in step 20 and replacing this sensitive information with the encrypted version thereof. In the preferred embodiment, this encryption is done immediately upon entry of the data and recognition that it is sensitive. In alternative embodiments, the sensitive information can be encrypted after a fixed or programmable delay or only after the user gives an encrypt command. In an alternative embodiment, the sensitive information can be replaced with a locator key which can be used to locate the encrypted version which may be stored elsewhere on a secure server or in a secure file on the same computer on which the document being processed resides. Immediate replacement of the sensitive information with its encrypted version or a locator key results in a piece of sensitive information immediately disappearing from the display and any stored version of the document immediately upon entry of the information. This prevents unscrupulous employees from memorizing the information. For example, suppose a mortgage loan officer is filling out a mortgage loan application on a client computer with a form having fields to enter bank account numbers, current address, credit card numbers, etc. Each of these pieces of information is sensitive information and would be recognized as such in step 20. As soon as the loan officer types in an entry into any one of these fields, it will be instantly encrypted and replaced with the encrypted version.

In some embodiments, public-private key pairs are used to encrypt pieces of sensitive information. In these embodiments, a public key is used to encrypt each segment of sensitive information selected in step 20, and then the public key is discarded. Then a pointer to the public key (or the private key since they come in pairs) and identifying the particular segment of a document or database record which was encrypted with said public key is generated and stored in the document itself or is stored in some secure file on the client computer which processed said document or database record or is stored on the key server.

One preferred way of generating and storing such a pointer is to generate a unique segment ID for each encrypted segment and, if the segment ID is not globally unique as explained in connection with the discussion of FIGS. 9 and 10, generating a unique document ID which does not change when the name of the file containing the document or database record is changed. The globally unique segment ID is then prepended to the actual encrypted version of the sensitive information in the document or database record and the encrypted version and the globally unique segment ID are then used to replace the sensitive information in the document or database record. If a globally unique segment ID is not used, a segment ID which is unique within the document or database itself along with the document ID is prepended to the encrypted version of the sensitive information and used to replace the sensitive information in the document, as illustrated in FIG. 9.

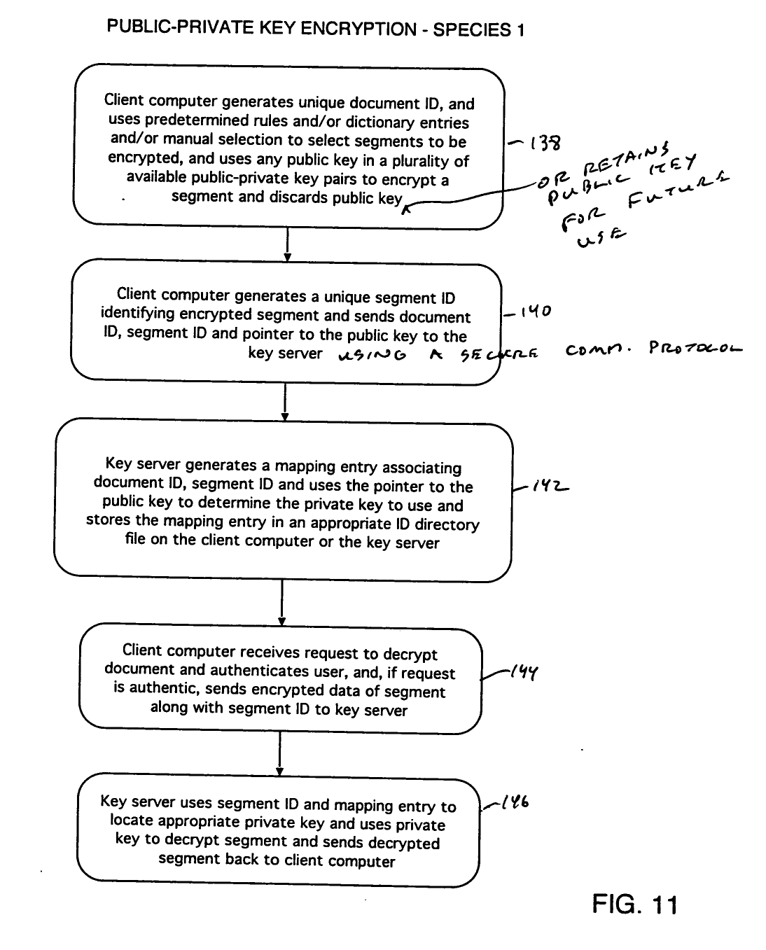

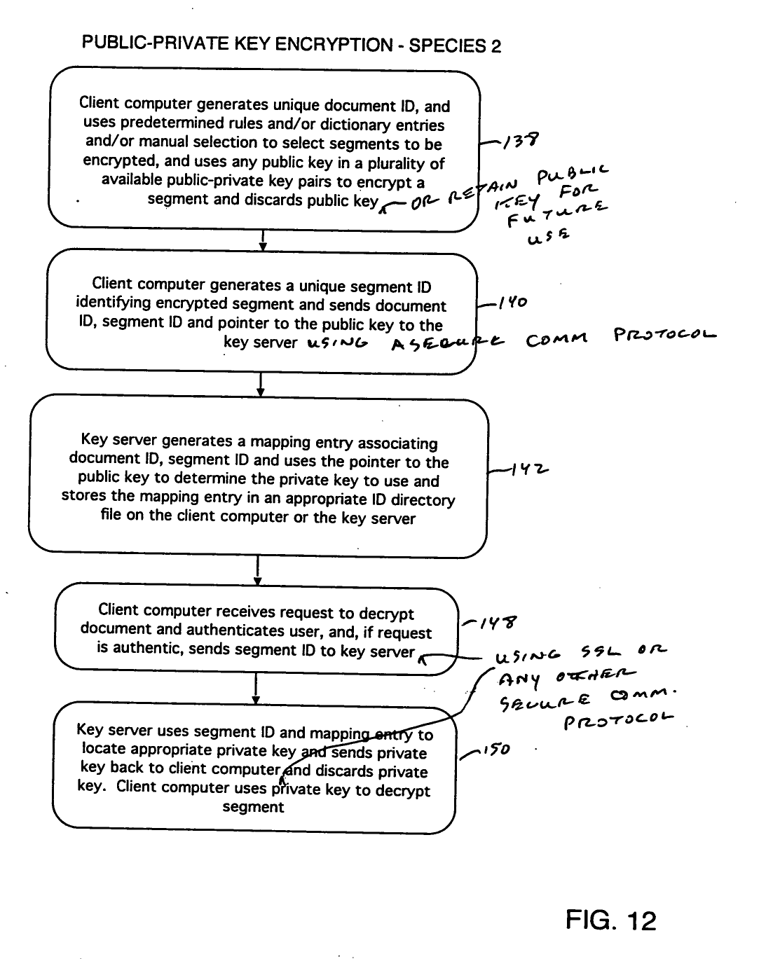

Two processes to use public-private key encryption are illustrated in FIGS. 11 and 12. Referring to FIG. 11, step 138 represents the client computer generating a unique document ID when a new document or database is created. This step is skipped when the user opens an already existing document or database which already exists and which has been partially encrypted, and the existing document ID, and new segment IDs and pointers to the public key used to encrypt each segment are sent to the key server for purposes of generating a mapping entry.

Step 138 also represents the process of selecting sensitive information to be encrypted by using the predetermined rules and/or dictionary entries and/or manual selection of sensitive information to be encrypted. Step 138 also represents the process of encrypting each sensitive information segment using a public key selected from a plurality of public-private key pairs which are available for encryption. After encryption of a segment, the public key is discarded. In alternative embodiments, the public key may be retained for future use so as to not deplete the public-private key pair pool.

Step 140 represents generating a unique segment ID for each sensitive information segment which is encrypted and sending the segment ID, the document ID and a pointer to the public key used to encrypt the sensitive information to the key server. In the preferred embodiment, the transmission of the segment ID, document ID and pointer to the public key is transmitted to the key server using the secure SSL or any other secure communication protocol. In the preferred embodiment, the encrypted information and the document ID and the segment ID are concatenated and used to replace the sensitive information in the document.

Step 142 represents the key server process of receiving the document ID, segment ID and pointer to the public key and creating a mapping entry for an ID directory table stored on a client computer or the key server. The key server uses the pointer to the public key to find the corresponding private key and records the private key or some pointer thereto in the mapping entry so that the document ID, segment ID and private key can all be associated. The key server then stores the mapping entry in the appropriate ID directory file.

In step 144, the client computer receives a request to decrypt a document or database record, and responds by authenticating the user. If the requester is authentic and is authorized to have the decryption performed, the client computer sends the encrypted data to be decrypted along with the segment ID to the key server. The key server uses the segment ID as a search key to search the ID directory file and find the private key needed to do the encryption in step 146. The key server then uses the private key to decrypt the encrypted segment received from the client computer and sends the decrypted data back to the client computer for inclusion in the document or database. In some embodiments, the decrypted data is sent back from the key server using a secure SSL protocol or any other secure communication protcol. In general, all communications with the key server can be made in various species using a secure SSL or any other secure communication protocol which uses a session key to encrypt the data transferred and discards the session key after the session is finished.

FIG. 12 represents another species similar to the species of FIG. 11 but wherein the decryption is done by the client computer using the private key sent by the key server. Steps 138, 140 and 142 are identical to like numbered steps in FIG. 11. The difference arises in steps 148 and 150. In step 148, the client computer receives a request to decrypt a document or database and authenticates the user. If the user is authentic and is authorized to have the decryption, step 148 sends the segment ID of each segment to be decrypted to the key server using the secure SSL or any other secure communication protocol. The key server uses these segment IDs to look up the private keys that will be needed to decrypt the segments in step 150 and sends the private keys to the client computer using the secure SSL or any other secure communication protocol, and then discards the private key(s). The client computer uses the private key(s) to decrypt the segment(s) and displays the decrypted data in the displayed version of the document or database record.

Returning to the consideration of the generic process of FIG. 2, step 24 represents the process of storing the encryption keys used to encrypt each piece of sensitive information on a secure server coupled by a local area network to the client computer on which the document is created or input in any other manner. In the case of a document containing sensitive information being created on or input to a stand alone computer, the encryption keys are stored in a secure file on a stand alone computer. The secure file may be a hidden file in some embodiments. The same key may be used to encrypt all items of sensitive information in the same document or a different key may be used to encrypt each piece of sensitive information. In the preferred embodiment, every document is given a unique code and each piece of sensitive information is encrypted with a unique key. The unique document code with the unique key for each piece of sensitive information are then stored, usually together, in a table or database for later retrieval. One example of such a key storage table is shown in FIG. 3. In this embodiment, a table is used with one column devoted to each document. Each column has a plurality of rows in which the individual keys are stored that were used to encrypt the various pieces of sensitive information in the order in which the sensitive information was encountered. In other embodiments, each piece of sensitive information is numbered, and the rows of each column are correspondinging numbered. The key used to encrypt each numbered piece of sensitive information is then stored in the corresponding numbered row. In other embodiments, each key has appended or prepended to it the document identifier and an identifier that identifies which piece of sensitive information was encrypted with the key. The resulting string is stored in a table or database.

After a document is protected in the manner of steps 20 through 24, it must be decrypted to be usable. However, access to thee decrypted document can be limited to just one or a handful of trusted employees. This may be done by keeping a list of who is authorized to access a collection of documents or even a list of who is authorized to access a particular document. Step 26 represents the process of authenticating a user who has requested access to a document to verify the user is who he says he is and whether he is on the list of persons authorized to have access to the document or collection of documents. This authentication process can be by any known security method such as by challenging for a user name and password, automated voiceprint identification, automated retinal identification, automated fingerprint reader, etc. Once the person is authenticated, step 26 also checks his identity against the names or numbers of persons on the list of persons authorized to access the document.

Step 28 represents the process of receiving a request from a user authenticated in step 26 to decrypt a particular document, looking up the appropriate keys for decryption of the document and decrypting the pieces of sensitive information in the document for display, printing or re-storing as a document in the clear. The keys are looked up using the document identifier and the identifier of each piece of sensitive information in the document as search keys to search the table or data base in which the keys are stored.

### Example Rules for Selection of of Sensitive Information for Encryption

Some typical rules for automated selection of sensitive information for encryption follow. A set of rules is needed for each type of sensitive information that needs to be recognized, removed and replaced with an encrypted version. For the examples that follow, assume that a word processing document is being screened by the recognition rules (as opposed to a spreadsheet). The principals of rule based identification are the same in both cases however.

In the preferred embodiment, a temporary dictionary of encoded items of sensitive information is kept so that the document may be re-scanned and other instances of sensitive information that may have previously gone undetected may be discovered.

Note that the rules are preferably tight because over inclusion of material for encryption does not harm the security offered nor harm the document. For example Rule 1 below for recognition of proper names will result in two word city names also being encrypted such as Saint Paul or Grand Rapids or El Segundo. However, the city names are not lost nor does it do serious harm to encrypt them. Since the partially encrypted document in not really useful until it is decrypted, the encryption of the extra information does no harm.

### Social Security Numbers

Social security numbers take the pattern xxx-xx-xxxx such as 123-45-6789.

Rule 1: a typical automated recognition rule for social security numbers would be:

Does the number have a total of 9 digits?
If so, does the number take the pattern 3 digits, -, 2 digits, -, 4 digits where “-” could be a hyphen, a space or any other filler character?
   If the answers to both these questions is yes, the number is deemed to be a social security number and is selected for encryption.
   Rule 2: where the SSN is labelled as such:
Does the number have a total of 9 digits?
Is the number preceded by a string which includes “Social Security” or “SSN” Proper Names

Proper names take the form first name, middle name or initial, last name, such as John T. Smith.

Rule 1:

Is there a capitalized string followed by another capitalized string ( . . . John Smith . . . ).
If so, the two capitalized strings will be automatically selected for encryption.
   Rule 2:
Any grammar or syntax rule or sentence construction that usually has a proper noun precede or follow a certain word or phrase such as “Smith said . . . ” or “ . . . was sent to Smith” will have the proper noun automatically selected for encryption.
   Rule 3:
Any word or phrase which is not found in the dictionary as a common word in the English language will be assumed to be a proper noun and automatically selected for encryption.
   Rule 4:
Any usage of a common title or prefix such as Mr., Mrs., Ms., named, given name, family name, middle name, etc. followed by a capitalized string will have the capitalized string automatically selected for encryption.
   Rule 5:
Lists having headings such as “name”, “persons”, “members”, “directors”, “shareholders”, etc. or any other common reference that is usually followed by the name of a person.

### Phone Numbers

Rule 1:

Is the number a numeric string of 7, 10 or 11 digits (or however many digits there are in phone numbers of the country of interest) with spaces, dashes or other filler characters according to set phone number patterns, such as 1-xxx-xxx-xxxx or xxx-xxxx? If so, encrypt the string. Many standard patterns exist for the US, Europe and other countries to identify a phone number in a text document or spreadsheet.
   Rule 2
Is there a 7, 10 or 11 digit string following a string “phone” or “phone number” or “work number” or “home number” or “cell” or “phone #” or “FAX” or “FAX number”, etc? If so, encrypt the numeric string.
   Rule 3
Is there a list with heading “phone” or “phone number” or “work number” or “home number” or “cell” or “phone #” or “FAX” or “FAX number”, etc. where items in the list are numeric strings having the above defined pattern? If so, encrypt each number in the list.

### Address

Rule 1:

Is there a numeric string followed by one or more capitalized words with no period between the numeric string and the next capitalized word? If so, encrypt the numeric string and the capitalized words following it.

### Mother's Maiden Name or Other Account Password

Rule 1:

Is there a string preceded by or nearly preceded by (or followed by) a string “maiden”, “MMN”, “maiden name”, “account password”, “password” or “PSW”? If so, encrypt the string that follows the label (or precedes it).
   Rule 2:
Is there a name detected as a proper name by any one of the preceding Proper Name detection rules? If so, encrypt it.
   Rule 3:
Is there a word which is used in conjunction with account numbers and/or a list of other sensitive information in a list.
   Some of the above rules require a dictionary of sensitive terms to be kept on the client computer or stand alone computer against which terms in the document are to be compared. Some of the rules require checking a grammar checker resource to determine if a word is used as a noun or verb. Others of the rules require patterns of numeric strings such as phone numbers or social security numbers to be recognized. Full dictionaries, grammar checkers and lists of patterns can be kept on the client computer without compromising the security of the information being protected in the document.

As the invention is used, it will become easier to identify and code in rules that will more efficiently identify sensitive information within a document. Further, in some embodiments, certain writing conventions such as the use of double quotes “” . . . “” around text in a document to be encrypted can be used to automatically trigger a recognition rule to encrypt the text between the double quotes.

For illustration, assume we are trying to capture for encryption a U.S. address buried in a text document. The U.S. address has the specific form 1234 Fifth Street, Los Angeles, Calif. 12345. If we look at the type of text in this sequence, it might be described as: number; capitalized words; city (recognized from city library in dictionary); state (recognized from state library in dictionary); number. A starting set of rules would be:
find all text sequences that have the pattern: number followed by a capitalized word followed by a city recognized from the library of cities in the dictionary followed by a state recognized from the state library of the dictionary followed by any know abbreviation of the United States as recognized from said dictionary followed by a number or followed by just a number or not followed by anything.
There may be blank spaces or punctuation within this sequence but no other text is permitted in the midst of the pattern.

Running these rules against a document would clearly catch the address given above in the example and it also would make an overinclusion error by catching the following item (indicated in bold) in a document discussing the frequency of occurrence of certain street names in American cities: “There are 3456 Fifth Streets. Los Angeles, Calif. 1000 . . . ”

Further, these rules would make an underinclusion error by not catching the following sensitive information which should be caught and encrypted: “He lives at 1234 Fifth Street in Los Angeles.”

The first error can be dealt with by adding a new rule:
The sequence cannot have any periods in it and the number following the state must be recognized as a valid zip code in a zip code library of said dictionary.

The second example, an underinclusion error, can be dealt with by adding a set of segments that conform to the formula:
sentence including address reference words recognized from the dictionary such as “address”, “lives” or “located” either at the beginning or end of the sentence; number followed by capitalized word or words followed by less than 10 characters excluding periods followed by a city name recognized by the list of cities in the dictionary.
   This more inclusive definition can be added to the rules given above such that any text pattern that trips either rule will be selected for encryption and less formal formulations of address will trigger the encryption process.

### Learning Process To Modify Rules

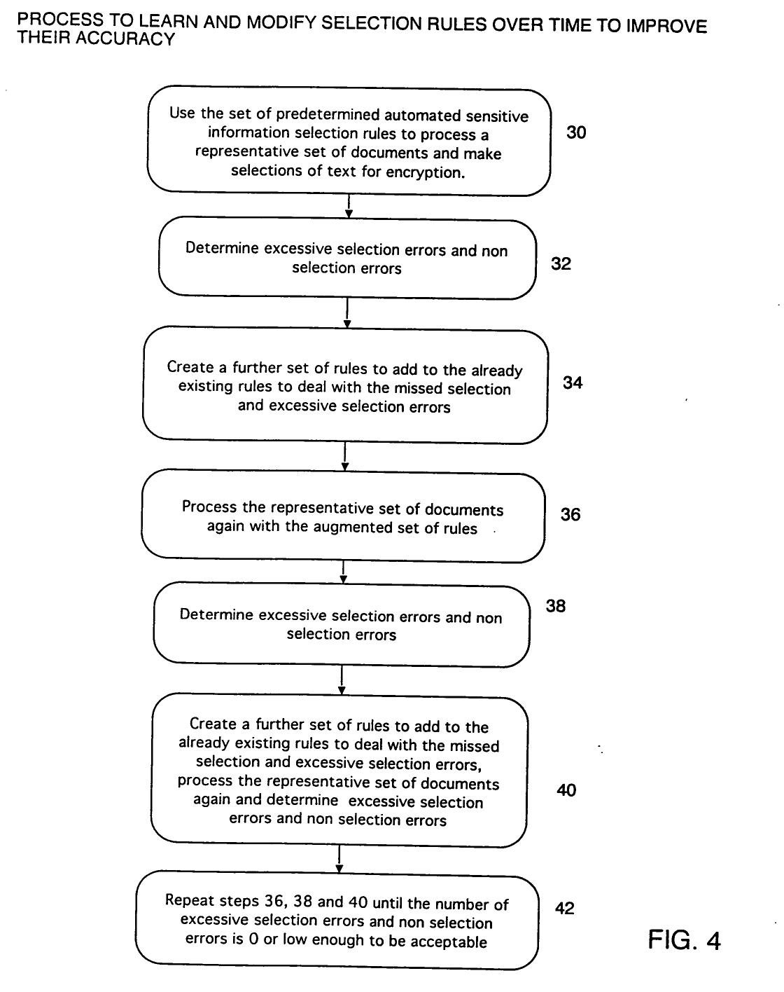

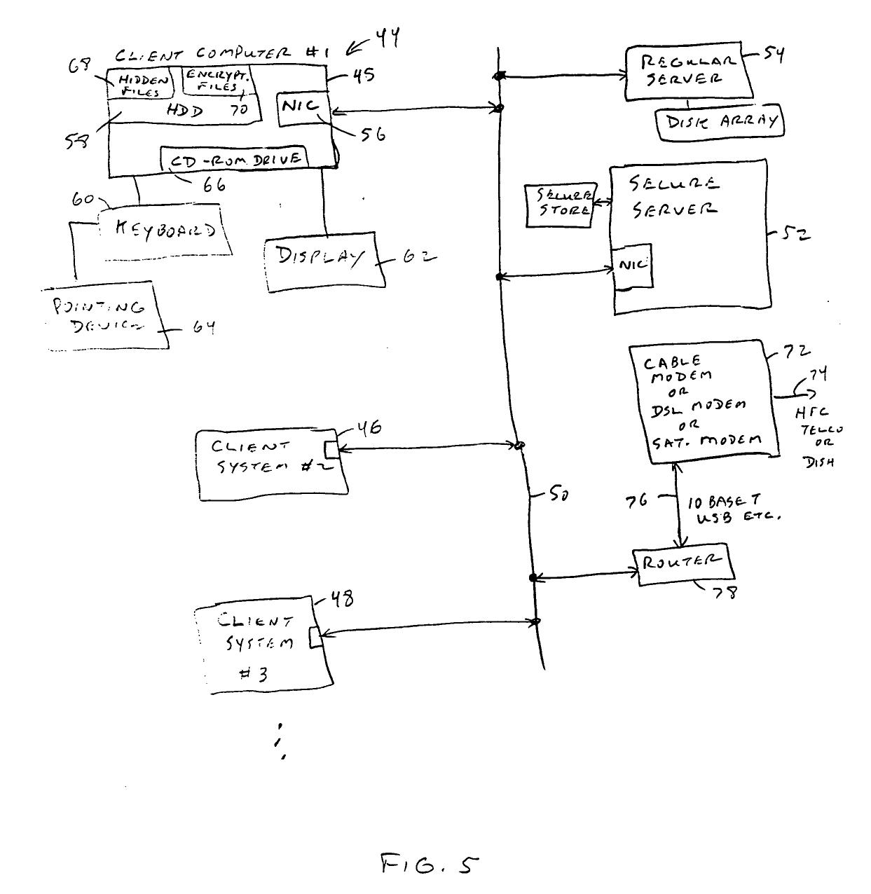

As there are always limitations and errors in any set of rules created for the purpose of selecting text within a document where the text is meant to embody a specific meaning, it is important to have a learning process by which the rules may be modified to improve the accuracy of the recognition and selection process. The process to learn and modify selection rules over time to improve the accuracy of selection is illustrated in the flowchart of FIG. 4. First, a set of sensitive text recognition rules must be written and coded such as the rules defined above. Then, in step 30, the set of predetermined sensitive text recognition rules is used to process a representative set of documents and make selections of text for encryption. It is important for this process to pick a representative set of documents which is a very good representation of the spectrum of documents that will be the bulk of the documents processed by the security application in actual operation.

Step 32 represents the process of determining the errors of selection and non selection. This is done by comparing the text that was selected for encryption by operation of an automatic rule to the actual documents and determining if any text was selected which should not have been. This is a manual step in some embodiments, but in other embodiments, a duplicate set of the documents processed by the automated selection rules are marked by a human operator with some delineators which mark all the sensitive information that should have been selected by the automated rules. No text which is not sensitive text is marked. The duplicate set of documents with the text selected manually is then compared in a computer process to the automatically selected text to determine the missed selection errors and the excessive selection errors. Missed selection errors are sensitive text that should have been selected by the automated selection rules but were not. Excessive selection errors are text items which were selected for encryption but which were not selected by the automated encryption rules.

Step 34 represents the process of creating an additional set of automated selection rules to add to the set of rules used to process the documents previously. The purpose of these additional rules it to deal with the missed selection and excessive selection errors made by the existing set of rules. The rules are written by a human and coded into code to control a computer to carry out the rules. The representative set of documents is then processed again in step 36 with the augmented set of rules.

In step 38, the excessive selection errors and non selection errors are determined again in any of the ways discussed above with reference to step 32. In step 40, a further set of rules is created to add to the existing set of rules to handle the new excessive selection errors and the missed selection errors. Then, the representative set of documents is processed again, and the excessive selection and non-selection errors are determined again. The process of steps 36, 38 and 40 are repeated until the number of excessive selection errors and non selection errors is zero or low enough to be acceptable, as symbolized by step 42.

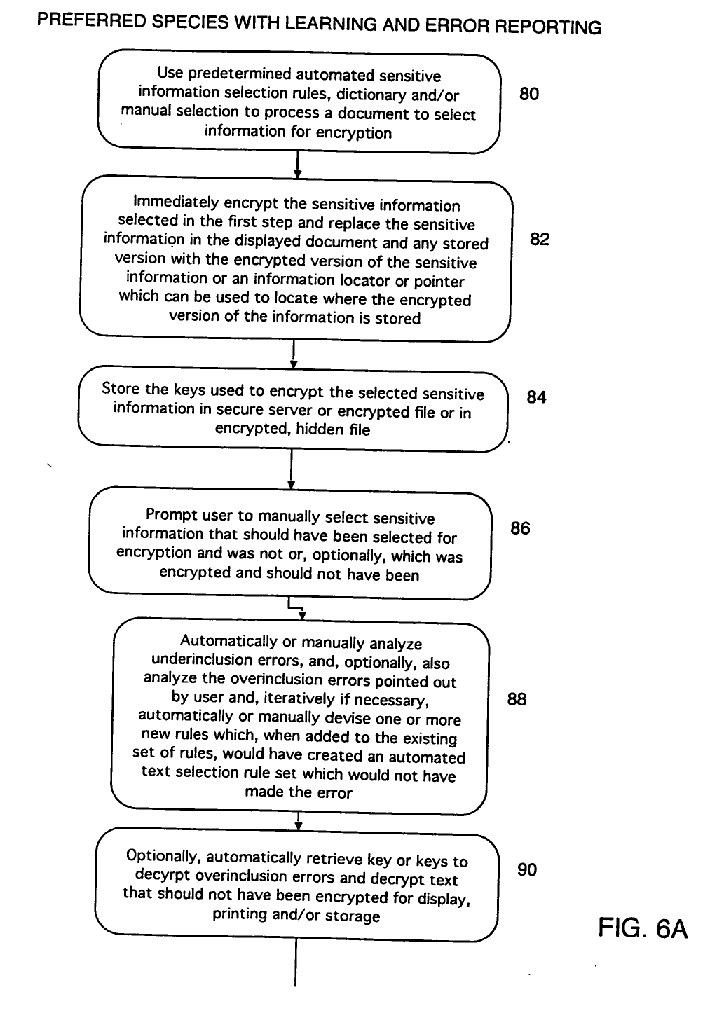

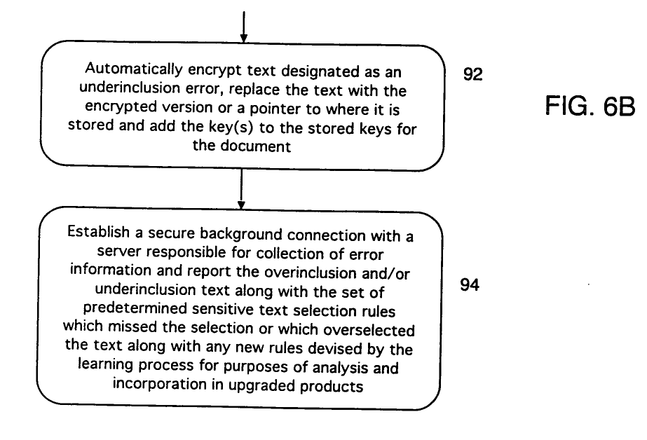

Typically, this learning process goes on in the background for upgrade products. In other words, the invention will have tools or menu commands that the user can invoke when an error of inclusion or an error of omission is noted, and the user corrects it. In some embodiments, the security application will automatically generate one or more new rules and/or dictionary entries which would correct the error pointed out by the user and add the new rule(s) and/or dictionary entry or entries to the existing rule set and/or dictionary. In other embodiments, the security application will also have an internet client application that makes an error report in the background to the assignee of the invention that includes information about the error that can be used by the assignee to add new automatic recognition rules or modify existing automatic recognition rules to correct the error in upgrade products or adds the new rule(s) and/or dictionary entries to the existing rule set/dictionary by a subsequent download. This preferred embodiment is illustrated in FIGS. 5 and 6. FIG. 5 is a hardware block diagram that illustrates a typical installation in which the invention is practiced. FIG. 6 is a flow diagram of the preferred species of the invention that includes a learning process and an automatic error reporting process.

Referring to FIG. 5, three typical client computer systems 44, 46 and 48 are shown coupled to a secure server 52 and a regular server 54 via a local area network 50. Each client system is comprised of a computer 45, a keyboard 60 or any other means for manually entering numbers and letters and punctuation and control codes, a pointing devices 64 such as a mouse, touchpad or touchscreen, a display 62, a hard disk 58 which may have hidden files 68 and encrypted files 70, and the client system may also have a CD-ROM drive 66 for reading in documents stored on CD-ROM. Each client computer also has a network interface card or NIC as does each of the servers. Optionally, the system may be connected to the internet or other wide area network via a cable modem, DSL modem or satellite modem 72 and transmission medium 74. The modem is coupled to the LAN 50 through a 10BaseT or USB, etc. link 76 to a router 78 which is coupled to the LAN. This router gives each client an IP address or a local address which is translated to a globally unique IP address in a Network Address Translation process in the router or another circuit which is not part of the router (not shown). This is only necessary in embodiments where background error reporting for purposes of improving upgrade products is employed.

Referring to FIG. 6, there is shown a flowchart of the process of the preferred embodiment which uses a learning process to adapt the rules to correct errors and a reporting process to report errors. Step 80 is the use of the predetermined automatic selection rules, a dictionary and/or manual selection rules to process a document to select text for encryption. This recognition and selection step is performed continuously in the background like a spell checker in the illustrated embodiment, but could be performed as a batch process on a plurality of documents or a separate process after a single document is completed in other embodiments.

In step 82, the selected text is encrypted as soon as it is selected, and the sensitive text is replaced immediately in the displayed and stored versions of the document with the encrypted version or a pointer to where the encrypted version is stored. The pointer can be a server ID concatenated with a document ID concatenated with a key ID which identifies the key used to encrypt a particular part of a document. In some embodiments, the same key is used to encrypt every section of sensitive information in the document. In such a case, the pointer is just the server ID and the document ID.

In step 84, the key or keys (some embodiments use only a single key to encrypt every piece of sensitive information in a document) used to encrypt the selected sensitive information are stored in the secure server or in an encrypted file on the client computer or in an encrypted, hidden file on the client computer (or stand alone computer).

In step 86, the learning process starts with the user being prompted to select any sensitive text that was missed or, optionally, to select any encrypted area of the document that should not have been encrypted. The user then drags his mouse (or selects in any other way) over any sensitive information that should have been encrypted and gives an underinclusion error command to indicate to the computer that this text was not selected by any of the automated processes for encryption and should have been. Optionally, user then drags his mouse over encrypted versions of the document that the user knows should not have been selected for encryption and gives an overinclusion error command to signal the computer which text of the document was included for encryption that should not have been.

The process then automatically analyzes the underinclusion errors in step 88. In some embodiments, overinclusion errors are also automatically or manually analyzed. The learning process then automatically, or manually in some embodiments, devises new rules (or modifies existing rules) and/or dictionary that, if used originally, would have resulted in a set of rules which would not have made the underinclusion (and, optionally, the overinclusion) errors. In alternative embodiments, the underinclusion errors (and, optionally, the overinclusion errors) are analyzed manually by the operator of the client system, and the new rules or modifications of the preexisting rules and/or dictionary is done manually.

In optional step 90, the key or keys needed to decrypt any overinclusion errors are automatically retrieved and the overincluded text is decrypted and re-displayed and stored in the clear in any stored version of the document.

In step 92, the text which was manually selected and indicated as an underinclusion error is automatically encrypted and replaced with the encrypted version thereof or a pointer to where the encrypted version of the text is stored. The key or keys used to encrypt the one or more segments of underincluded text is then automatically added to the set of stored keys for the document.

In step 94, a secure background connection such as an https protocol connection is established between the process of FIG. 6 and a server which is responsible for collecting error reports. This is done using router 78 and cable modem 72 to automatically access the internet or some other wide area network and address packets containing the error report to the error report collection server. After a connection is set up, the process represented by step 94 reports the text reported by the user as an underinclusion error (and overinclusion errors also, optionally) along with the set of predetermined sensitive text selection rules and/or dictionary which were used and which resulted in the error. Also reported are any new rules devised in step 88 in an attempt to overcome the error. The error report collecting server stores all this information in a database for analysis to develop improvements in upgrade products.

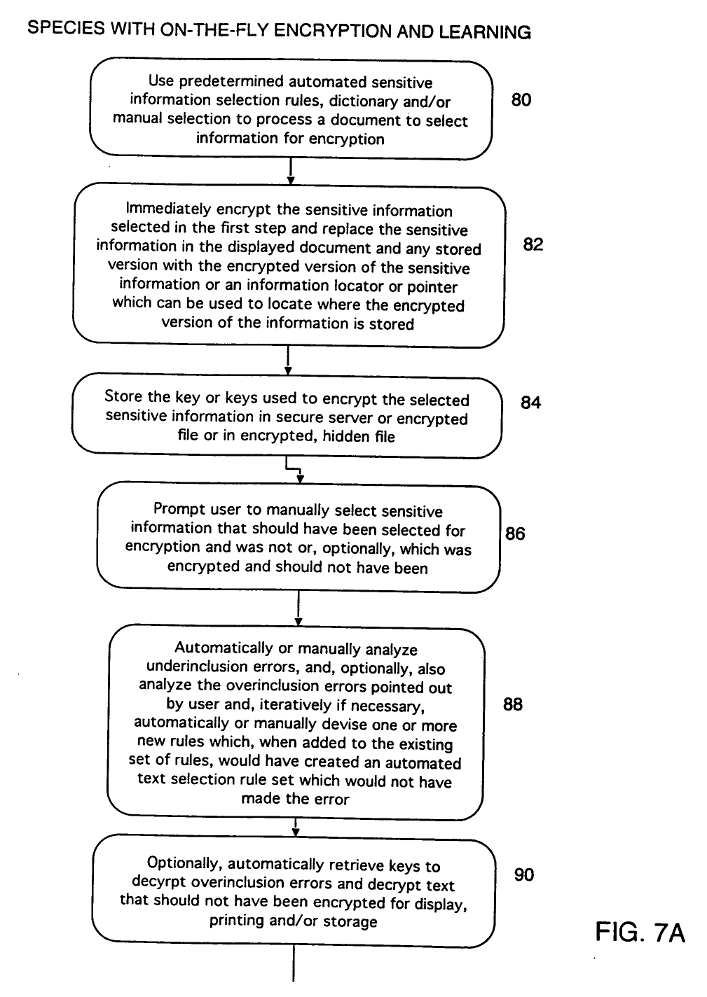

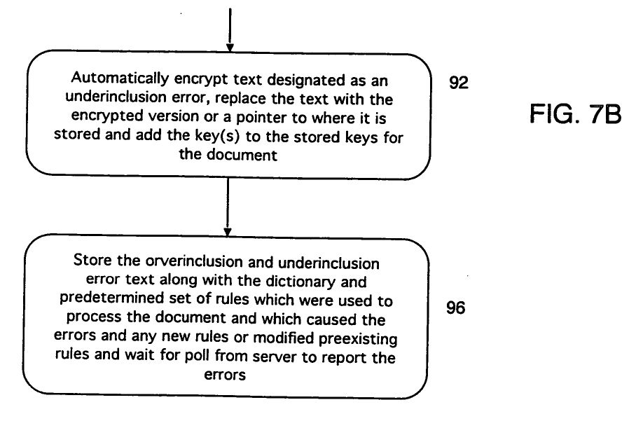

FIG. 7, comprised of FIGS. 7A and 7B, is a flowchart of an alternative embodiment where the client system does on the fly encryption and learning, but does not automatically report errors to a server somewhere, but stores them and waits of a server to ask for them. All the steps 80 through 92 are identical to like numbered steps in the embodiment of FIG. 6. Step 96 is new and represents the process of storing the overinclusion and underinclusion error text along with the dictionary and predetermined set of automatic selection rules which were used to process the document and which caused the error along with any new rule or modification to an existing rule which were devised to fix the error. This information is stored on the client computer which waits for a server at the location of the manufacturer of the invention to establish a secure connection to the client computer and ask for the data.

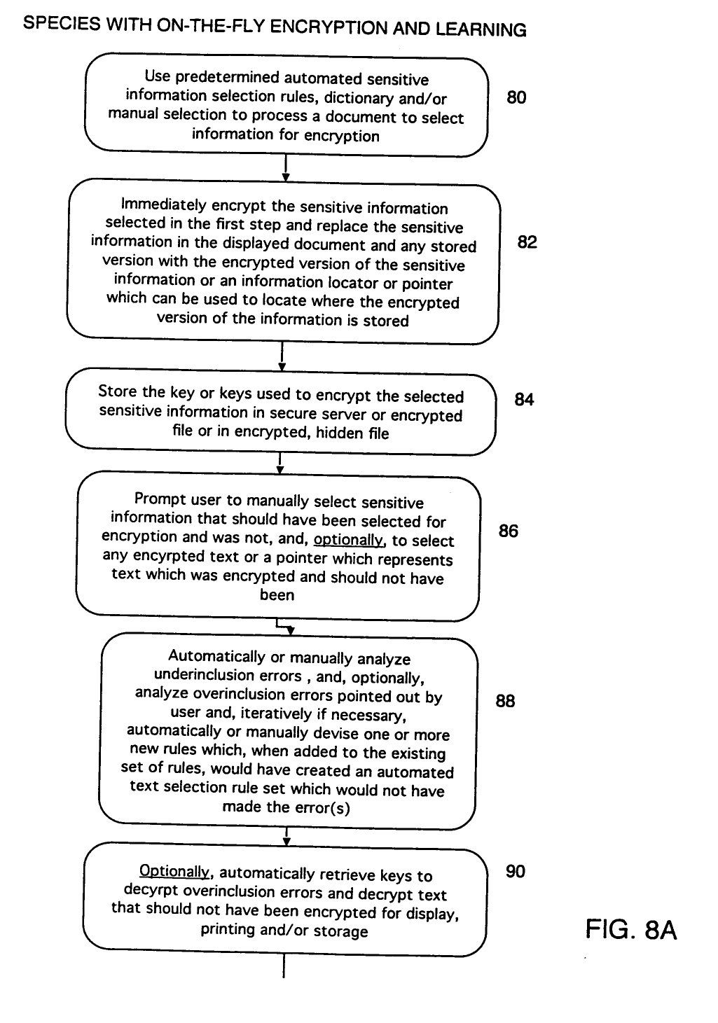

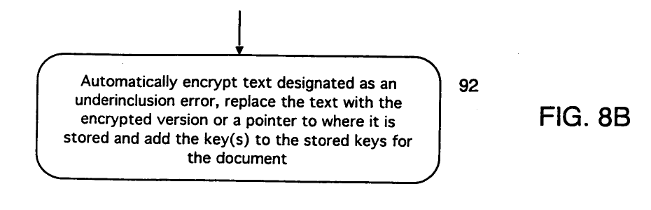

FIG. 8, comprised of FIGS. 8A and 8B, is a flowchart of an alternative embodiment where a client system does on the fly encryption and learning only with no error storage or reporting. All of steps 80 through 84 are identical with the steps previously described with reference to FIG. 6. In step 86 however, the user is prompted to point out underinclusion errors by manually selecting sensitive text which was not selected for encryption but which should have been. In alternative embodiments, the user can also be prompted to point out overinclusion errors by selecting encrypted versions of text or pointers thereto which represent text which was selected and encrypted but which should not have been. Overinclusion errors are not a big problem since the document is already rendered unusable to persons without access to the keys so some additional missing text is not important since it gets restored automatically when an authorized user asks for the document to be restored and is authenticated.

Step 88 automatically or manually analyzes the underinclusion errors and, iteratively, if necessary, automatically or manually devises one or more new selection rules (or modifies existing rules) and/or adds a new dictionary entry which, when added to the automated text selection rules and/or dictionary, would have created an automated text selection rule set and/or dictionary which would not have made the underinclusion error(s). Optionally, overinclusion errors are analyzed also if any are flagged by the user and new rules or modifications to rules are devised to correct the error. Step 90 is an optional step of retrieving the key or keys used to encrypt the overinclusion errors and decrypting the overinclusions and re-display of the decrypted text and storing the decrypted text in any stored version of the document. In step 92, the text which was manually selected and signalled by the user to be an underinclusion error is automatically encrypted and replaced with the encrypted version or a pointer to where the encrypted version of the text is stored and the key or keys used to encrypt the underinclusion error text is added to the store of key or keys used to encrypt the other pieces of sensitive information in the document.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A process to encrypt sensitive information in a document in real time, comprising the steps:
1) selecting for encryption in any way sensitive information in any document or database record which is displayed and/or stored on a computer;
2) encrypting said selected sensitive information immediately upon selection or after a delay and replacing the sensitive information with an encrypted version thereof or a pointer to find an encrypted version of said sensitive information which has been stored elsewhere and pointer information that enable location of the key needed to decrypt the encrypted version of the sensitive information;
3) storing the key or keys used to encrypt the sensitive information encrypted in step 2 in a secure storage location;
4) receiving a request from a user who wishes to have access to a document which has been protected using steps 1-3 and authenticating the user as one who is on a list of users authorized to have access to the document; and
5) if the user is authenticated in step 4, retrieving the keys used to encrypt sensitive information in said document or database record, decrypting said information, and displaying and/or printing the decrypted document or database record for said authenticated user.

2. The process of claim 1 wherein step 1 is accomplished using a dictionary of sensitive terms and comparing terms in the document to terms in said dictionary.

3. The process of claim 1 wherein step 1 is accomplished using predetermined pattern recognition rules that use patterns to select sensitive information for encryption.

4. The process of claim 1 wherein step 1 is accomplished using manual selection by providing a tool whereby a user may put specially recognized delimiters around text to be encrypted.

5. The process of claim 1 wherein step 1 is accomplished using any combination or all of the following techniques: 1) using a dictionary of sensitive terms and comparing terms in the document to terms in said dictionary; 2) using predetermined pattern recognition rules that use patterns to select sensitive information for encryption; 3) using manual selection by providing a tool whereby a user may put specially recognized delimiters around text to be encrypted; and/or 4) automatically encrypting any field in a database record where the semantic meaning of the field name indicates the field will contain sensitive information, and wherein the selection of sensitive information is made as the document or database record is being created or later as a batch process when the document is saved or designated by the user for processing or wherein said step of selection of sensitive information is done using a set of scripted find and replace or other suitable commands that operate on a file to find sensitive information, encrypt it and replace the sensitive information with a encrypted version thereof along with suitable pointers to locate the key needed to decrypt the information or pointers to enable location of the encrypted version of the information and the key needed to decrypt said information.

6. The process of claim 1 wherein step 3 is accomplished by storing said encryption key or keys on a secure server which is coupled by a local area network to said computer upon which said document is displayed.

7. The process of claim 1 wherein step 3 is accomplished by storing said encryption key or keys in a file stored on said computer upon which said document is displayed, and encrypting said file.

8. The process of claim 1 wherein said encryption key or keys are stored in a secure, hidden file.

9. The process of claim 1 wherein authentication step 4 is carried out by challenging said user for a user name and password.

10. The process of claim 1 wherein authentication step 4 is carried out by challenging said user with a question based upon the personal history of the user that only said user can answer.

11. The process of claim 1 wherein step 2 stores a pointer to the encryption key used to encrypt a selected section of a document as a server ID concatenated with a document ID.

12. A process comprising:
1) using predetermined automated sensitive information selection rules, a dictionary of sensitive terms and/or manual selection to process a document to select sensitive information for encryption;
2) immediately encrypting sensitive information selected in step 1 and replacing the sensitive information in any displayed and any stored version of the document with the encrypted version thereof or a pointer to where the encrypted version of the sensitive information is stored;
3) storing the key or keys used to encrypt the sensitive information encrypted in step 2 in a secure server or in a secure file on the computer which stores and/or displays the document processed by steps 1 and 2;
4) prompting a user to inspect the document processed in step 2 to select any text that should have been selected and encrypted but which was not and give any indication that this text is an underinclusion error;
5) analyze the underinclusion errors signalled in step 4, and, iteratively if necessary, devise a new automatic selection rule and/or dictionary entry which, if added to the existing set of automatic selection rules and/or dictionary before processing the document, would have eliminated or reduced the underinclusion errors to an acceptable level; and
6) automatically encrypt text designated as an underinclusion error and immediately replace the underincluded text with an encrypted version thereof or a pointer to where said encrypted version thereof is stored, and adding the key or keys used to encrypt said one or more portions of underincluded text to the store of one or more keys used to encrypt other sensitive pieces of information in said document.

13. The process of claim 12 wherein step 5 is done automatically.

14. The process of claim 12 wherein step 5 is done manually.

15. The process of claim 12 wherein step 4 includes prompting the user to select overinclusion portions of said document and indicate said portions are overinclusion errors, and wherein step 5 also involves manual or automatic analysis of overinclusion errors and automatic or manual devising of one or more new automatic selection rules or modification of one or more preexisting automatic selection rules and/or said dictionary such that if said new rule(s) and/or dictionary entry or entrys had been added to the existing set of rules and dictionary, said overinclusion error(s) would not have occurred.

16. The process of claim 12 further comprising the steps:
automatically establishing a secure connection over the internet or some other wide area or local area network with a server responsible for collection of error information;
reporting the underinclusion error information along with the set of predetermined sensitive text selection rules and/or dictionary that were used to process the document and which caused the error to occur and reporting any new rules or modification to existing rules and/or said dictionary devised by the process of learning step 5.

17. The process of claim 12 further comprising the steps:
storing any reported underinclusion error text along with the dictionary and predetermined set of sensitive text selection rules which caused said underinclusion error, and storing any new rules or modifications to existing rules which were devices in learning step 5 to correct the error;
when a server establishes a connection and requests error reports, sending said stored information to said server.

18. A process comprising steps for:
1) using predetermined automated sensitive information selection rules, a dictionary of sensitive terms and/or manual selection to process a raw document to select sensitive information for encryption;
2) immediately encrypting sensitive information selected in step 1 and replacing the sensitive information in any displayed and any stored version of the document with the encrypted version thereof or a pointer to where the encrypted version of the sensitive information is stored;
3) storing the key or keys used to encrypt the sensitive information encrypted in step 2 in a secure server or in a secure file on the computer which stores and/or displays the document processed by steps 1 and 2;
4) determine at least where underinclusion errors occurred;
5) analyze the underinclusion errors signalled in step 4, and, devise one or more new automatic selection rules and/or one or more new dictionary entry or entries which, if added to the existing set of automatic selection rules and/or dictionary before processing the document, would have eliminated or reduced the underinclusion errors; and
6) automatically encrypting text designated as an underinclusion error and immediately replacing the underincluded text with an encrypted version thereof or a pointer to where said encrypted version thereof is stored, and adding the key or keys used to encrypt said one or more portions of underincluded text to the store of one or more keys used to encrypt other sensitive pieces of information in said document.

19. The process of claim 18 wherein step 4 determines both over inclusion and underinclusion errors, and is accomplished automatically by using a computer to compare the document processed in steps 1 and 2 with a duplicate document which has been marked with delimiters which signal the beginning and end of each item of sensitive information that should have been encrypted and determining where overinclusion errors occurred where text was encrypted which was not set off by said deliminters and determining where underinclusion errors occurred where text marked by delimiters which signals it should have been encrypted was not encrypted.

20. The process of claim 18 further comprising steps for:
7) processing said raw document processed in step 1 again using said new set of rules developed in step 5 to select text for encryption;
8) determining at least any underinclusion errors which occurred after processing said document;
9) analyzing at least said underinclusion errors and devising one or more new rules and/or dictionary entries which would prevent said underinclusion errors from occurring again; and
10) repeating steps 7, 8 and 9 until the number of at least underinclusion errors reaches an acceptable number.

21. The process of claim 19 further comprising steps for:
7) processing said raw document processed in step 1 again using said new set of rules developed in step 5 to select text for encryption;
8) determining both any underinclusion errors and overinclusion errors which occurred after processing said document;
9) analyzing said underinclusion errors and said overinclusion errors, and devising one or more new rules and/or dictionary entries which would prevent said underinclusion and overinclusion errors from occurring again; and
10) repeating steps 7, 8 and 9 until the number of at least said underinclusion errors reaches an acceptable number.

22. A process comprising steps for:
1) using predetermined automated sensitive information selection rules, a dictionary of sensitive terms and/or manual selection to process a raw document to select sensitive information for encryption;
2) immediately encrypting sensitive information selected in step 1 and replacing the sensitive information in any displayed and any stored version of the document with the encrypted version thereof or a pointer to where the encrypted version of the sensitive information is stored;
3) storing the key or keys used to encrypt the sensitive information encrypted in step 2 in a secure server or in a secure file on the computer which stores and/or displays the document processed by steps 1 and 2;
4) receiving user input that an underinclusion or overinclusion error has occurred said user input including information about where in the document the error occurred;
5) analyze the errors signalled in step 4, and, devise one or more new automatic selection rules and/or one or more new dictionary entry or entries which, if added to the existing set of automatic selection rules and/or dictionary before processing the document, would have eliminated or reduced the errors; and
6) automatically encrypting text designated as an underinclusion error and immediately replacing the underincluded text with an encrypted version thereof or a pointer to where said encrypted version thereof is stored, and adding the key or keys used to encrypt said one or more portions of underincluded text to the store of one or more keys used to encrypt other sensitive pieces of information in said document.

23. The process of claim 22 wherein step 5 further comprises launching an internet client application, reporting the error reported by said user with details about the text that was overincluded or underincluded to a server on the internet, and receiving back one or more new rules and/or dictionary entries from said server and adding said one or more new rules and/or dictionary entries to said existing rules and/or dictionaries.

24. A computer-readable medium having computer-executable instructions stored thereon which control a computer to perform the following steps:
1) selecting for encryption in any way sensitive information in a document being displayed and/or generated and/or stored on a computer;
2) encrypting said selected sensitive information and replacing the sensitive information with an encrypted version thereof and a pointer to the key needed to decrypt said information or pointer information suitable to find an encrypted version of said sensitive information which has been stored elsewhere and a key needed to decrypt the encrypted information;
3) storing the key or keys used to encrypt the sensitive information encrypted in step 2 in a secure storage location;
4) receiving a request from a user who wishes to have access to a document which has been protected using steps 1-3 and authenticating the user as one who is on a list of users authorized to have access to the document; and
5) if the user is authenticated in step 4, retrieving the keys used to encrypt sensitive information in said document, decrypting said information, and displaying and/or printing the decrypted document for said authenticated user.

25. The computer-readable medium of claim 24 wherein said computer-executable instructions include instructions to control a computer to perform the following steps:
6) performing step 1 using predetermined pattern recognition rules that use patterns to select sensitive information for encryption and using a dictionary of terms that are considered sensitive.

26. A computer-readable medium having computer-executable instructions stored thereon which control a computer to perform the following steps:
1) using predetermined automated sensitive information selection rules, a dictionary of sensitive terms and/or manual selection to process a document;
2) encrypting sensitive information selected in step 1 and replacing the sensitive information in any displayed and/or any stored version of the document with the encrypted version thereof and a pointer to the key needed to decrypt said sensitive information, or pointer information suitable to indicate where the encrypted version of the sensitive information is stored and where a key needed to decrypt the sensitive information may be found;
3) storing the key or keys used to encrypt the sensitive information encrypted in step 2 in a secure server or in a secure file on the computer which stores and/or displays the document processed by steps 1 and 2;
4) prompting a user to inspect the document processed in step 2 to select any text that should have been selected and encrypted but which was not and give any indication that this text is an underinclusion error;
5) analyze the underinclusion errors signalled in step 4, and, iteratively if necessary, devise a new automatic selection rule and/or dictionary entry which, if added to the existing set of automatic selection rules and/or dictionary before processing the document, would have eliminated or reduced the underinclusion errors to an acceptable level; and
6) automatically encrypting text designated as an underinclusion error and immediately replacing the underincluded text with an encrypted version thereof or a pointer to where said encrypted version thereof is stored, and adding the key or keys used to encrypt said one or more portions of underincluded text to the store of one or more keys used to encrypt other sensitive pieces of information in said document.

27. The computer-readable medium of claim 26 further comprising computer-executable instructions which control a computer to accomplish step 4 by prompting the user to select overinclusion portions of said document and indicate said portions are overinclusion errors, and wherein said computer-executable instructions include instructions to control said computer to accomplish step 5 by doing automatic analysis of overinclusion errors and automatically devise one or more new automatic selection rules or modification of one or more preexisting automatic selection rules and/or said dictionary such that if said new rule(s) and/or dictionary entry or entrys had been added to the existing set of rules and dictionary, said underinclusion and/or overinclusion error(s) would not have occurred.

28. The computer-readable medium of claim 27 further comprising computer-executable instructions which control a computer to perform the following steps:
7) processing said raw document processed in step 1 again using said new set of rules developed in step 5 to select text for encryption;
8) determining at least any underinclusion errors which occurred after processing said document;
9) analyzing at least said underinclusion errors and devising one or more new rules and/or dictionary entries which would prevent said underinclusion errors from occurring again; and
10) repeating steps 7, 8 and 9 until the number of at least underinclusion errors reaches an acceptable number.

29. The computer-readable medium of claim 27 further comprising computer-executable instructions which control a computer to perform the following steps:
automatically establishing a secure connection over the internet or some other wide area or local area network with a server responsible for collection of error information;
reporting the underinclusion error information along with the set of predetermined sensitive text selection rules and/or dictionary that were used to process the document and which caused the error to occur and reporting any new rules or modification to existing rules and/or said dictionary devised by the process of learning step 5.

30. A computer-readable medium having computer-executable instructions stored thereon which control a computer to perform the following steps:
1) using predetermined automated sensitive information selection rules, a dictionary of sensitive terms and/or manual selection to process a raw document being displayed and/or generated and/or stored on a computer to select sensitive information for encryption;
2) encrypting sensitive information selected in step 1 and replacing the sensitive information in any displayed and/or any stored version of said document with the encrypted version thereof and a pointer to a key used to encrypt said sensitive information, or pointer information indicating where the encrypted version of the sensitive information is stored and a key needed to decrypt said sensitive information may be found;
3) storing the key or keys used to encrypt the sensitive information encrypted in step 2 in a secure server or in a secure file on the computer which stores and/or displays the document processed by steps 1 and 2;
4) determining at least where underinclusion errors occurred;
5) analyzing the underinclusion errors signalled in step 4, and, devising one or more new automatic selection rules and/or one or more new dictionary entry or entries which, if added to the existing set of automatic selection rules and/or dictionary before processing the document, would have eliminated or reduced the underinclusion errors; and
6) automatically encrypting text designated as an underinclusion error and immediately replacing the underincluded text with an encrypted version thereof or a pointer to where said encrypted version thereof is stored, and adding the key or keys used to encrypt said one or more portions of underincluded text to the store of one or more keys used to encrypt other sensitive pieces of information in said document.

31. The computer-readable medium of claim 30 having stored thereon further computer-executable instructions which control a computer to perform step 4 by receiving user input which indicates which text in a document was overincluded and which text was underincluded.

32. The computer-readable medium of claim 31 having stored thereon further computer-executable instructions which control a computer to perform step 4 by comparing said document which has been processed by the process of step 1 to a document which has been processed manually to include delimiters around text that should be included for encryption and using said comparison results to determine where overinclusion and underinclusion errors occurred.

33. The computer-readable medium of claim 30 having stored thereon further computer-executable instructions which control a computer to perform the following additional steps:
7) processing said raw document processed in step 1 again using said new set of rules developed in step 5 to select text for encryption;
8) determining at least any underinclusion errors which occurred after processing said document;
9) analyzing at least said underinclusion errors and devising one or more new rules and/or dictionary entries which would prevent said underinclusion errors from occurring again; and
10) repeating steps 7, 8 and 9 until the number of at least underinclusion errors reaches an acceptable number.

34. The computer-readable medium of claim 30 having stored thereon further computer-executable instructions which control a computer to launch an internet client application, reporting the error reported by said user with details about the text that was overincluded or underincluded to a server on the internet, and receiving back one or more new rules and/or dictionary entries from said server and adding said one or more new rules and/or dictionary entries to said existing rules and/or dictionaries.

35. The computer-readable medium of claim 31 having stored thereon further computer-executable instructions which control a computer to launch an internet client application, reporting the error reported by said user with details about the text that was overincluded or underincluded to a server on the internet, and receiving back one or more new rules and/or dictionary entries from said server and adding said one or more new rules and/or dictionary entries to said existing rules and/or dictionaries.

36. The computer-readable medium of claim 32 having stored thereon further computer-executable instructions which control a computer to launch an internet client application, reporting the error reported by said user with details about the text that was overincluded or underincluded to a server on the internet, and receiving back one or more new rules and/or dictionary entries from said server and adding said one or more new rules and/or dictionary entries to said existing rules and/or dictionaries.

37. A process comprising:
1) creating a unique document ID which does not change when the file name of a document or database is changed, said step of creating a document ID occurring at least when said document or database is created for the first time;
2) using rules, dictionary entries and/or operator selection and/or any other process to select sensitive information in a document or database for encryption;
3) selecting a segment of said document or database which has be selected for encryption and generating a segment ID which is unique at least within said document or database;
4) sending said document ID and said segment ID to a key server with a request to issue a key;
5) receiving back a key from said key server using a secure communication protocol, and using said key to encrypt said segment associated with said document ID and said segment ID, and replacing said segment with the encrypted version thereof;
6) prepending or appending to said encrypted version of said segment, said document ID and said segment ID; and
7) repeating steps 3 through 7 as many times as necessary to encrypt each said segment identified in step 2.

38. The process of claim 37 wherein steps 3 through 6 are performed only after a fixed or programmable interval has elapsed from the time step 2 selects a segment of a document or database for encryption or only after a user enters a command to partially encrypt a document.

39. The process of claim 37 further comprising the following steps carried out by a security application executing on a key server:
8) receiving said document ID and segment ID and a request to issue a key;
9) creating a mapping entry associating said document ID with said segment ID and with a key server pointer to said key server and with a key pointer to a particular key stored on said key server which will be issued in response to said key request;
10) sending back to a client computer which issued said key request said key pointed to by said key pointer using a secure communication protocol;
11) storing said mapping entry in a secure ID directory file.

40. The process of claim 37 further comprising steps for:
12) determining in any way if said rules and/or dictionary entries resulted in at least underinclusion errors;
13) analyzing said errors and devising new rules and/or dictionary entries which would have reduced or eliminated said errors and adding said rules and/or dictionary entries to said set of rules and dictionary entries used in step 2.

41. A process for partially encrypting documents in a system comprising at least one computer or one or more client computers coupled via a local area network to at least one key server, comprising:
1) using rules, dictionary entries and/or operator selection and/or any other process to select for encryption sensitive information in a document or database being created or modified in a system comprising at least one computer or one or more client computers coupled via a local area network to at least one key server;
2) selecting a segment of said document or database which has be selected for encryption and generating a segment ID which is globally unique within at least all said documents or databases in said system;
3) sending said segment ID to a key server with a request to issue a key;
4) receiving back a key from said key server, and using said key to encrypt said segment associated with said segment ID, and replacing said segment with the encrypted version thereof;
5) prepending or appending to said encrypted version of said segment, said said segment ID; and
6) repeating steps 2 through 6 as many times as necessary to encrypt each said segment identified in step 1.

42. The process of claim 41 further comprising the following steps carried out by a security application executing on a key server:
7) receiving said segment ID and a request to issue a key;
8) creating a mapping entry associating said segment ID and with a key server pointer to said key server and with a key pointer to a particular key stored on said key server which will be issued in response to said key request;
9) sending back to a client computer which issued said key request said key pointed to by said key pointer using a secure communication protocol;
10) storing said mapping entry in a secure ID directory file.

43. The process of claim 41 further comprising steps for:
11) determining in any way if said rules and/or dictionary entries resulted in at least underinclusion errors;
12) analyzing said errors and devising new rules and/or dictionary entries which would have reduced or eliminated said errors and adding said rules and/or dictionary entries to said set of rules and dictionary entries used in step 2.

44. A computer-readable medium having stored thereon a data structure, comprising:
a first field containing data representing a document ID identifying a particular document or database;
a second field containing data representing a segment ID identifying a particular portion of said document or database which has been encrypted;
a third field containing data pointing to a key server on which is stored a key which was used to encrypt said segment identified by said segment ID; and
a fourth field containing data pointing to a particular key stored on said key server which was used to encrypt said segment identified by said segment ID.

45. A computer-readable medium having stored thereon a data structure, comprising:
a first field containing a segment ID which which uniquely identifies a segment of a document or database which contains sensitive information; and
a second field containing an encrypted version of said sensitive information.

46. The computer-readable medium of claim 45 wherein said segment ID is globally unique.

47. The computer-readable medium of claim 45 wherein said segment ID is unique within said document or database, and further comprising:
a third field containing a document ID which uniquely identifies said document or database and which does not change when the file name of said document or database changes.

48. A process comprising steps for:
1) selecting for encryption in any way sensitive information in a document or database record created on a computer using a security application which incorporates therein whatever functionality of an application program written using the component object model (com) standard software architecture needed to create, edit, print and/or store said document or database record;
2) encrypting said selected sensitive information immediately or after a delay and replacing the sensitive information with an encrypted version thereof and information to find the key needed to decrypt said information or a pointer to find an encrypted version of said sensitive information which has been stored elsewhere and a key to decrypt said information;
3) storing the key or keys used to encrypt the sensitive information encrypted in step 2 in a secure storage location;
4) receiving a request from a user who wishes to have access to a document which has been protected using steps 1-3 and authenticating the user as one who is on a list of users authorized to have access to the document; and
5) if the user is authenticated in step 4, retrieving the keys used to encrypt sensitive information in said document or database, decrypting said information, and displaying and/or printing the decrypted document or decrypted fields in a database record for said authenticated user.

49. A computer-readable medium having computer-executable instructions stored thereon which control a computer to perform the following steps:
1) select for encryption in any way sensitive information in a document or database record created on a computer using a security application which incorporates therein whatever functionality of an application program written using the component object model (com) standard software architecture needed to create, edit, print and/or store said document or database record;
2) encrypt said selected sensitive information immediately or after a delay and replace the sensitive information with an encrypted version thereof and information to find the key needed to decrypt said information or a pointer to find an encrypted version of said sensitive information which has been stored elsewhere and a key to decrypt said information;
3) store the key or keys used to encrypt the sensitive information encrypted in step 2 in a secure storage location;
4) receive a request from a user who wishes to have access to a document which has been protected using steps 1-3 and authenticating the user as one who is on a list of users authorized to have access to the document; and
5) if the user is authenticated in step 4, retrieve the keys used to encrypt sensitive information in said document or database, decrypt said information, and display and/or print the decrypted document or decrypted fields in a database record for said authenticated user.

50. A process for partially encrypting documents using public-private key pairs, comprising steps for:
1) when a document or database is created or opened and said document or database does not have a document ID, creating a unique document ID for said document which will not change if the name of the file containing the document or database is changed;
2) using predetermined rules and/or dictionary entries and/or manual selections and/or semantic definitions of database fields to select sensitive information in said document or database for encryption;
3) selecting a segment of sensitive information identified in step 2, and using any public key from a plurality of public-private key pairs to encrypt a segment of sensitive information, and discarding said public key;
4) generating a unique segment ID to identify the segment of sensitive information just encrypted;
5) using said document ID, said segment ID and a pointer to said public key used to encrypt said segment to a key server to generate a mapping entry which associates said document ID to said segment ID to a private key associated with said public key and storing said mapping entry in a secure ID directory file;
6) repeating steps 3-5 for all other segments of sensitive information in said document or database entry;
7) receiving a request to decrypt a partially encrypted document or database record, and authenticating the requester;
8) if the requester is authentic and authorized to view or print the decrypted document or database record, using said private key associated with each encrypted segment to decrypt said segment and allowing the user to view or print the decrypted document or database record.

51. A computer-readable medium having stored thereon computer-executable instructions to control a computer to carry out the following process:
1) when a document or database is created or opened using said computer and said document or database does not have a document ID, creating a unique document ID for said document which will not change if the name of the file containing the document or database is changed;
2) using predetermined rules and/or dictionary entries and/or manual selections and/or semantic definitions of database fields to select sensitive information in said document or database for encryption;
3) selecting a segment of sensitive information identified in step 2, and using any public key from a plurality of public-private key pairs to encrypt a segment of sensitive information, and discarding said public key;
4) generating a unique segment ID to identify the segment of sensitive information just encrypted;
5) using said document ID, said segment ID and a pointer to said public key used to encrypt said segment to a key server to generate a mapping entry which associates said document ID to said segment ID to a private key associated with said public key and storing said mapping entry in a secure ID directory file;
6) repeating steps 3-5 for all other segments of sensitive information in said document or database entry;
7) receiving a request to decrypt a partially encrypted document or database record, and authenticating the requester;
8) if the requester is authentic and authorized to view or print the decrypted document or database record, using said private key associated with each encrypted segment to decrypt said segment and allowing the user to view or print the decrypted document or database record.

52. A process to encrypt sensitive information in a document comprising the steps:
1) selecting for encryption in any way sensitive information in any document or database record which is displayed and/or stored on a computer, said selection including recognition of a special control characters entered by a user at the beginning and end of text or selection of all text typed after a predetermined first hot key combination is entered until a second predetermined hot key combination is entered or said predetermined first hot key combination is entered again, said text between said special control characters or all text entered after said first hot key combination is entered and before said predetermined hot key combination or reentry of said predetermined first hot key combination being encrypted immediately upon entry even where other sensitive information selected in any other way will not be encrypted immediately but will be encrypted after some fixed or programmable delay;
2) encrypting said selected sensitive information which is not immediately encrypted after a fixed or programmable delay;
3) storing the key or keys used to encrypt the sensitive information encrypted in step 2 in a secure storage location;
4) receiving a request from a user who wishes to have access to a document which has been protected using steps 1-3 and authenticating the user as one who is on a list of users authorized to have access to the document; and
5) if the user is authenticated in step 4, retrieving the keys used to encrypt sensitive information in said document or database record, decrypting said information, and displaying and/or printing the decrypted document or database record for said authenticated user.

53. The process of claim 52 wherein step 2 further comprises the steps of replacing the sensitive information with an encrypted version thereof or a pointer to find an encrypted version of said sensitive information which has been stored elsewhere along with pointer information that enables location of the key needed to decrypt the encrypted version of the sensitive information.

54. The process of claim 52 wherein step 2 further comprises the steps of replacing the sensitive information with a configurable set of characters such as asterisks or a predetermined name and storing the encrypted version of said sensitive information elsewhere and storing in said database record or word processing document pointer information that enables location of the key needed to decrypt the encrypted version of the sensitive information.

55. A computer-readable medium having stored thereon computer-executable instructions which cause a computer executing said instructions to perform the following process:
1) selecting for encryption in any way sensitive information in any document or database record which is displayed and/or stored on a computer, said selection including recognition of a special control characters entered by a user at the beginning and end of text or selection of all text typed after a predetermined first hot key combination is entered until a second predetermined hot key combination is entered or said predetermined first hot key combination is entered again, said text between said special control characters or all text entered after said first hot key combination is entered and before said predetermined hot key combination or reentry of said predetermined first hot key combination being encrypted immediately upon entry even where other sensitive information selected in any other way will not be encrypted immediately but will be encrypted after some fixed or programmable delay;
2) encrypting said selected sensitive information which is not immediately encrypted after a fixed or programmable delay;
3) storing the key or keys used to encrypt the sensitive information encrypted in step 2 in a secure storage location;
4) receiving a request from a user who wishes to have access to a document which has been protected using steps 1-3 and authenticating the user as one who is on a list of users authorized to have access to the document; and
5) if the user is authenticated in step 4, retrieving the keys used to encrypt sensitive information in said document or database record, decrypting said information, and displaying and/or printing the decrypted document or database record for said authenticated user.

56. The computer-readable medium of claim 55 having further stored thereon computer-executable instructions which cause any computer executing said instructions to perform the following additional steps:
replacing the selected sensitive information in a display of said document or database record with a configurable set of characters such as asterisks or a predetermined name and storing the encrypted version of said sensitive information elsewhere and storing in said database record or word processing document pointer information that enables location of the key needed to decrypt the encrypted version of the sensitive information.
